(19) United States
(12) Patent Application Publication
(10) Pub. No.: US 2010/0095235 A1
(43) Pub. Date: Apr. 15, 2010

(54) Enterprise Information Security Management Software Used to Prove Return on Investment of Security Projects and Activities Using Interactive Graphs

(75) Inventors: Jeff Bennett, Livermore, CA (US); Mike Stager, Tracy, CA (US); Gordon Shevlin, Livermore, CA (US); William Tang, Arcadia, CA (US)

Correspondence Address: AKA CHAN LLP, 900 LAFAYETTE STREET, SUITE 710, SANTA CLARA, CA, 95050, US

(73) Assignee: ALLGRESS, INC., Livermore, CA (US)

(21) Appl. No.: 12/420,818

(22) Filed: Apr. 8, 2009

Related U.S. Application Data
(60) Provisional application No. 61/043,336, filed on Apr. 8, 2008.
(60) Provisional application No. 61/084,571, filed on Jul. 29, 2008.

(51) Int. Cl. G06F 3/048; G06F 3/033

(52) U.S. Cl. 715/781

(57) ABSTRACT

Asset security is tracked and managed by the system. In a specific implementation, assets are entered into the system. The system automates gathering security information about the asset by, for example, sending out surveys and aggregating the responses. The system performs a security gap analysis by comparing the responses against a security maturity model. Tasks can be assigned to various users and then tracked so that vulnerabilities can be addressed. The system generates interactive summary reports (e.g., charts, graphs, animation) to help users make security decisions. Graphs may be temporally animated so that users can see and analyze changes over time.

### CROSS-REFERENCE TO RELATED APPLICATIONS

This patent application claims the benefit of U.S. provisional patent applications 61/043,336, filed Apr. 8, 2008, and 61/084,571, filed Jul. 29, 2008, which are incorporated by reference along with all other references cited in this application.

### BACKGROUND OF THE INVENTION

This invention relates to the field of information systems, and more specifically to enterprise information security.

Organizations and enterprises are essentially a collection of assets. An asset is anything that has value to an organization. Assets can range from data files to physical assets. Assets may also include intangibles such as an organization's reputation and the skill sets of its workforce.

These assets include a great deal of information. In many cases, the information is confidential. The information may concern employees, customers, products, research, and financial status. The information may be stored on a variety of media including, for example, disk drives, floppy disks, magnetic disks, optical disks, magneto-optical disks, fixed disks, hard disks, CD-ROMs, recordable CDs, DVDs, recordable DVDs (e.g., hard drives, magnetic disks. The information may also be recorded on paper and stored, for example, binders, folders, and file cabinets.

Protecting such information by ensuring its confidentiality, integrity, and availability is critical to an organization. Security breaches could allow new product lines to fall into the hands of competitors, lost business, law suits, identity theft, and even bankruptcy of the organization.

In many cases, protecting information is not only a business and ethical requirement, but it is also a legal requirement. Regulatory compliance is an important legal responsibility for many organizations. For example, the Sarbanes-Oxley Act (SOX) requires corporate officers to demonstrate the existence of various operational controls. Standard setting bodies such as the International Organization for Standardization (ISO) have extensive policies and procedures to help ensure, for example, regulatory compliance and the safeguard of assets and information.

Managing, securing, and monitoring an organization's assets and ensuring that the organization's policies and procedures comply with regulations can be daunting task. It requires, for example, developing an inventory of assets, defining responsible parties, establishing acceptable use polices, classifying and labeling information, and much more. This can be a very difficult and expensive process.

Therefore, there is a need for an improved system and method of enterprise information security.

### BRIEF SUMMARY OF THE INVENTION

Assets are tracked and managed by the system. In a specific implementation, the security of assets are tracked and managed. Assets are entered into the system. Assets may be imported from any data source. The assets are then classified. The system sends out automated surveys to various users to collect security compliance data. The surveys may be sent internally within an organization, externally to an organization, or both. For example, surveys may be sent to employees, third parties (e.g., partners, vendors, suppliers) to collect security compliance data.

Assets may be evaluated against any security maturity models such as International Organization for Standardization (ISO) 27001:2005 Information Technology—Security Techniques—Information Security Management Systems—Requirements, Sarbanes-Oxley Act of 2002 (SOX), Health Insurance Portability and Accountability Act (HIPAA), Gramm-Leach-Bliley Act (GLBA), North American Electric Reliability Corporation (NERC), California Senate Bill 1386 (SB 1386), and the like. Users may also develop their own security standards within the system.

Security gaps may be displayed in interactive graphs such as pie charts and bar charts. Users may click on the graphs to see more information.

The system provides various tools to help to mitigate and control vulnerabilities. For example, any number of security projects can be created within the system. The security projects may include workflows, task scheduling and tracking, and reminders. A centralized repository stores audit documentation.

The system provides various tools so the assets can be continuously monitored. This includes, for example, metrics and statistics, monitoring and reporting, status reports, and automated compliance updates. The system provides animated graphics to illustrate, for example, how the organization's security changes over time.

Some advantages of a system of the invention include:

1. Enabling business analysis for security operations.

2. Proving security projects and activities return on investment

3. Staying ahead of compliance requirements.

4. Establishing comprehensive security methodology and management metrics.

5. Demonstrating security value to various parties such as executive management and customers.

6. Visual presentation of security analysis and processes.

7. Customizable product design to fit individual client security process, procedures, and operations.

8. Avoiding reengineering costs and delays.

9. Automating information gathering to reduce labor hours.

10. Visual reporting for security analysis and business decisions.

In specific implementations, the system reduces time, labor, and costs by identifying what security gaps are the most expensive. The system helps the user determine which best practices (e.g., training, code reviews) provide the most security and business value. For example, the system's security assessment surveys may be sent to vendors in order to assess their security maturity. The system may be used to identify vulnerabilities, prioritize vulnerabilities, and quantify the costs to fix.

In specific implementations, the system reduces time, labor and costs for security compliance. For example, compliance requirements in Sarbanes-Oxley Act of 2002 (SOX), Health Insurance Portability and Accountability Act (HIPAA) may be mapped to International Organization for Standardization (ISO) 27001. Audit documentation may be centrally stored so that it can be easily produced.

In specific implementations, the system reduces time and effort spent conducting security reviews of new applications, infrastructure, and other technologies. For example, Intranet and Internet security best practices surveys can be customized to determine security risks, asset value, and security requirements. The assessment process may be automated and thus reduce the amount of labor hours needed.

In specific implementations, the system reduces the time and effort spent on identifying and analyzing new security regulatory requirements. For example, the system includes automated compliance updates. New and modified security compliance requirements typically require analysis and audit support. Automated or manual software updates with new security compliance analysis may be uploaded and benchmarked against various security models such as the ISO security model.

One benefit of the system is that it can be used to prove security return on investment. In other words, the system can be used to demonstrate the economic value of implementing security projects and activities over a period of time.

In an implementation, the method includes: in a first computer screen, providing a first portion of the screen with a plurality of user-adjustable options; in the first computer screen, providing a second portion of the screen with a graph having a first axis, a second axis, and at least one reference line; after a first user-selectable option is selected, animating a number of bubbles in the graph; and while the plurality of bubbles are being animated, not moving the at least one reference line from a fixed position, where the plurality of bubbles move in motion relative to the fixed position of the at least one reference line.

In various implementations, the reference line is a curved line. A first reference line of the at least one reference line is a straight line and a second reference line of the at least one reference line is a curved line. The reference line touches a point where the first axis and second axis touch. One of the plurality of user-adjust options comprises a display trails option.

The method of claim 1 further includes upon a user selecting one of the bubbles in motion at a first time step, displaying in a second screen information associated with the selected bubble at a time represented by the graph in the first time step. Upon a user selecting one of the bubbles in motion at a second time step, subsequent to the first time step, the method includes displaying in a third screen information associated with the selected bubble at a time represented by the graph in the second time step, where the information in the third screen is different from the information in the second screen.

For a first region of the graph that is a first distance range away from reference line, the first region is shown using a first color. For a second region of the graph that is a second distance range away from reference line, the second region is shown using a second color, different from the first. The method includes showing in the graph at least a first and third region in the first color; and showing in the graph at least a second and fourth region in the first color.

The first and second regions are on a first side of the reference line while the third and fourth regions are on a second side of the reference line. The in the first computer screen, providing a second portion of the screen with a graph having a first axis, a second axis, and at least one reference line includes: drawing the first reference line on the first screen using a broken line; and drawing the first axis using a solid line.

In an implementation, a method includes: in a first computer screen, drawing a first fixed reference line of a graph; drawing a second fixed reference line of the graph; drawing a third fixed reference line of the graph, where the third fixed reference line is not parallel to either the first fixed or second fixed reference line; animating a first circle and a second circle of the graph, whereby the first and second circle are in motion relative to the third fixed reference line; showing a first region of the graph that is a first distance range away from third reference line using a first color; and showing a second region of the graph that is a second distance range away from third reference line using a second color, different from the first.

The method includes: when hovering a pointing device over the first circle, displaying a numerical value that is representative of a distance of the first circle from the third reference line. As the first circle moves relative to the third reference line, the numerical value changes on the screen in real time.

In an implementation, a method includes: in a first computer screen, drawing a first fixed reference line of a graph; drawing a second fixed reference line of the graph; drawing a third fixed reference line of the graph, where the third fixed reference line is not parallel to either the first fixed or second fixed reference line; drawing a fourth fixed reference line of the graph, wherein the fourth fixed reference line is not parallel to either the first fixed, second fixed, or third fixed reference line; animating a first circle and a second circle of the graph, whereby the first and second circle are in motion relative to the third and fourth fixed reference lines; showing a first region of the graph that is between the third and fourth fixed reference lines using a first color; and showing a second region of the graph that is outside the third and fourth fixed reference lines using a second color, different from the first color. Further, in an implementation, the third fixed reference line is a straight line while the fourth fixed reference line a curved line.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a simplified block diagram of a client-server system and network in which an embodiment of the invention may be implemented.

FIG. 2 shows a more detailed diagram of an exemplary client or computer which may be used in an implementation of the invention.

FIG. 3 shows a system block diagram of a client computer system used to execute application programs such as a web browser.

FIG. 4 shows a block diagram of a specific implementation of a system of the invention.

FIG. 5 shows a computer screen displaying a specific implementation of an application window to view, input, delete, edit (i.e., customize) standards information.

FIG. 6 shows a computer screen displaying a specific implementation of an application window to enter asset information.

FIG. 7 shows a computer screen displaying a specific implementation of an application window to input an evaluation of the asset.

FIG. 8 shows a computer screen displaying an application window showing a specific implementation of wheel chart.

FIG. 9 shows a specific implementation of a flow diagram for drawing the wheel chart.

FIG. 10 shows a specific implementation of a flow diagram for coloring the wheel chart.

FIG. 11 shows a computer screen displaying an application window showing another implementation of a wheel chart.

FIG. 12 shows a flow diagram to color the wheel chart.

FIG. 13 shows a computer screen displaying an application window showing a specific implementation of an isometric (e.g., 3-D) wheel chart.

FIG. 14 shows a computer screen displaying an application window showing a specific implementation of a flattened wheel chart.

FIG. 15 shows a specific implementation of a flow diagram for drawing an isometric wheel chart.

FIG. 16 shows a computer screen displaying an application window showing a specific implementation of a gap analysis chart.

FIG. 17 shows a computer screen displaying an application window showing a specific implementation of a network security analysis trend tool.

FIG. 18 shows a specific implementation of a flow diagram for making a network security analysis trend tool.

FIG. 19 shows a computer screen displaying an application window showing a specific implementation of an isometric network security analysis trend tool.

FIG. 20 shows a computer screen displaying an application window showing a specific implementation of a risk level matrix.

FIG. 21 shows a specific implementation of a flow diagram for making the risk level matrix.

### DETAILED DESCRIPTION OF THE INVENTION

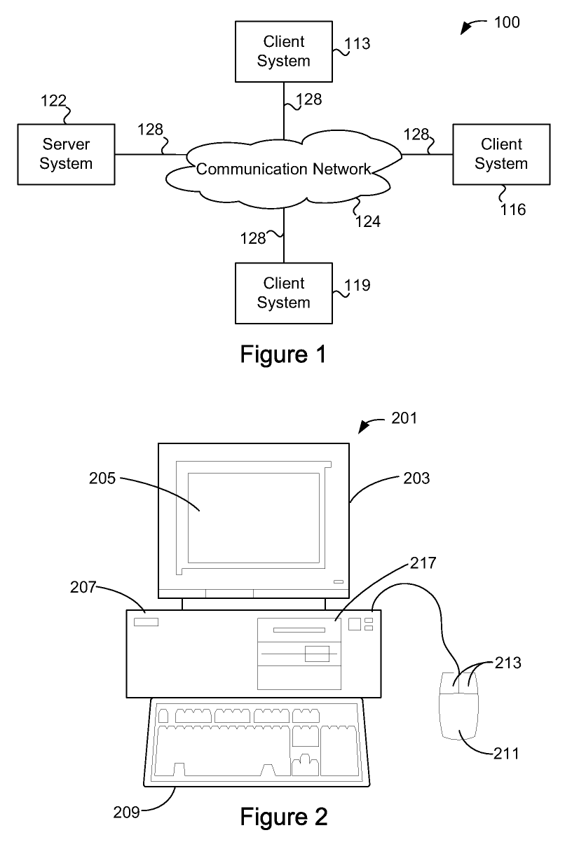

FIG. 1 is a simplified block diagram of a distributed computer network 100 incorporating an embodiment of the present invention. Computer network 100 includes a number of client systems 113, 116, and 119, and a server system 122 coupled to a communication network 124 via a plurality of communication links 128. Communication network 124 provides a mechanism for allowing the various components of distributed network 100 to communicate and exchange information with each other.

Communication network 124 may itself be comprised of many interconnected computer systems and communication links. Communication links 128 may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, and others. While in one embodiment, communication network 124 is the Internet, in other embodiments, communication network 124 may be any suitable communication network including a local area network (LAN), a wide area network (WAN), a wireless network, a intranet, a private network, a public network, a switched network, and combinations of these, and the like.

Distributed computer network 100 in FIG. 1 is merely illustrative of an embodiment incorporating the present invention and does not limit the scope of the invention as recited in the claims. One of ordinary skill in the art would recognize other variations, modifications, and alternatives. For example, more than one server system 122 may be connected to communication network 124. As another example, a number of client systems 113, 116, and 119 may be coupled to communication network 124 via an access provider (not shown) or via some other server system.

Client systems 113, 116, and 119 typically request information from a server system which provides the information. For this reason, server systems typically have more computing and storage capacity than client systems. However, a particular computer system may act as both a client or a server depending on whether the computer system is requesting or providing information. Additionally, although aspects of the invention has been described using a client-server environment, it should be apparent that the invention may also be embodied in a stand-alone computer system.

Server 122 is responsible for receiving information requests from client systems 113, 116, and 119, performing processing required to satisfy the requests, and for forwarding the results corresponding to the requests back to the requesting client system. The processing required to satisfy the request may be performed by server system 122 or may alternatively be delegated to other servers connected to communication network 124.

According to the teachings of the present invention, client systems 113, 116, and 119 enable users to access and query information stored by server system 122. In a specific embodiment, a “web browser” application executing on a client system enables users to select, access, retrieve, or query information stored by server system 122. Examples of web browsers include the Internet Explorer browser program provided by Microsoft Corporation, and the Firefox browser provided by Mozilla, and others.

FIG. 2 shows an exemplary client system (or server system) of the present invention. In an embodiment, a user interfaces with the system through a computer workstation system, such as shown in FIG. 2. FIG. 2 shows a computer system 201 that includes a monitor 203, screen 205, cabinet 207, keyboard 209, and mouse 211. Mouse 211 may have one or more buttons such as mouse buttons 213. Cabinet 207 houses familiar computer components, some of which are not shown, such as a processor, memory, mass storage devices 217, and the like.

Mass storage devices 217 may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), flash and other nonvolatile solid-state storage (e.g., USB flash drive), battery-backed-up volatile memory, tape storage, reader, and other similar media, and combinations of these.

A computer-implemented or computer-executable version (e.g., a computer program product) of the invention may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 217. The source code of the software of the present invention may also be stored or reside on mass storage device 217 (e.g., hard disk, magnetic disk, tape, or CD-ROM). As a further example, code of the invention may be transmitted via wires, radio waves, or through a network such as the Internet.

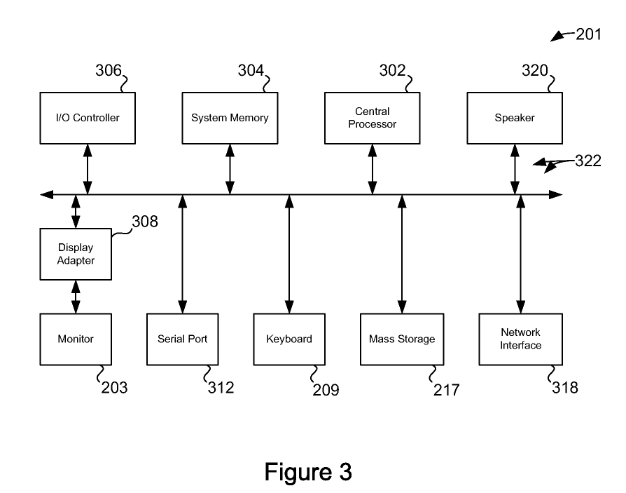

FIG. 3 shows a system block diagram of computer system 201 used to execute the software of the present invention. As in FIG. 2, computer system 201 includes monitor 203, keyboard 209, and mass storage devices 217. Computer system 501 further includes subsystems such as central processor 302, system memory 304, input/output (I/O) controller 306, display adapter 308, serial or universal serial bus (USB) port 312, network interface 318, and speaker 320. The invention may also be used with computer systems with additional or fewer subsystems. For example, a computer system could include more than one processor 302 (i.e., a multiprocessor system) or a system may include a cache memory.

Arrows such as 322 represent the system bus architecture of computer system 201. However, these arrows are illustrative of any interconnection scheme serving to link the subsystems. For example, speaker 320 could be connected to the other subsystems through a port or have an internal direct connection to central processor 302. The processor may include multiple processors or a multicore processor, which may permit parallel processing of information. Computer system 201 shown in FIG. 2 is but an example of a computer system suitable for use with the present invention. Other configurations of subsystems suitable for use with the present invention will be readily apparent to one of ordinary skill in the art.

Computer software products may be written in any of various suitable programming languages, such as C, C++, C#, Pascal, Fortran, Perl, Matlab (from MathWorks, www.mathworks.com), SAS, SPSS, JavaScript, AJAX, and Java. The computer software product may be an independent application with data input and data display modules. Alternatively, the computer software products may be classes that may be instantiated as distributed objects. The computer software products may also be component software such as Java Beans (from Sun Microsystems) or Enterprise Java Beans (EJB from Sun Microsystems).

An operating system for the system may be one of the Microsoft Windows® family of operating systems (e.g., Windows 95, 98, Me, Windows NT, Windows 2000, Windows XP, Windows XP x64 Edition, Windows Vista, Windows 7, Windows CE, Windows Mobile), Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

In an embodiment, with a web browser executing on a computer workstation system, a user accesses a system on the World Wide Web (WWW) through a network such as the Internet. The web browser is used to download web pages or other content in various formats including HTML, XML, text, PDF, and postscript, and may be used to upload information to other parts of the system. The web browser may use uniform resource identifiers (URLs) to identify resources on the web and hypertext transfer protocol (HTTP) in transferring files on the web.

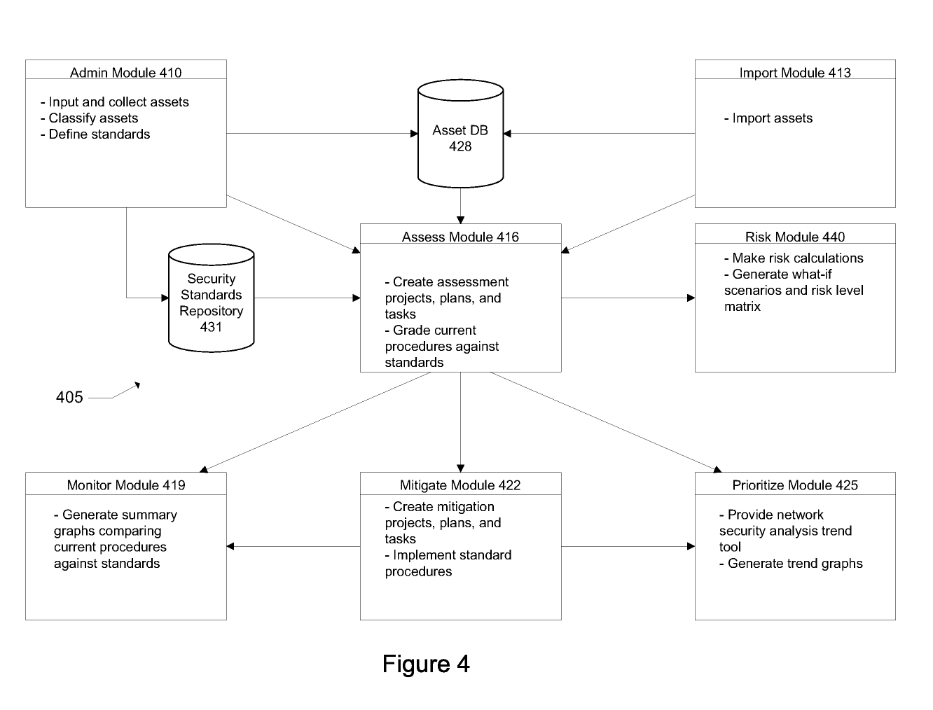

FIG. 4 shows a block diagram of a specific implementation of a system 405 of the invention. The system is an enterprise information security management software tool. This tool allows the user to evaluate security of a particular information system or network, in order to prove return on investment of security projects and activities. The results of the evaluation are provided by interactive graphs on a computer display. These graphs respond to user input (e.g., selected by using a mouse or other pointing device), so the particular information the user desires can be selected and displayed. The graphs also use color, isometric and three-dimensional perspectives, and other graphical elements in order to convey results or a large quantity of information (which also typically varies with time) to the user quickly. The user can quickly see a summary of data and how it changes over time. However, through the software tool, the user is also able to drill down to see the details, if the user so desires. For example, the user can “mouse over” to see some additional detail. Or the user can decide “click down” on a particular graphical element to see some detail for a subset of the data. Using such an approach, the software tool continues to allow the user to drill down to low levels of detail, if desired.

In one implementation, the system is available to users as an on-line application, such as the user accesses the application by logging in through a Web browser interface. Through a login interface, the on-line application can include access controls (e.g., passwords and encryption) that the user has to login through, before the user can access the application. The application may be written using a platform-independent language such as Java, Javascript, or AJAX, so that the application will run on a browser on any platform such as Windows, Mac OS X, UNIX, Linux, or Sun OS.

In another implementation, the system is available to users as a desktop application. The desktop application is downloaded (or provided via a CD-ROM, DVD, or other storage device) and then installed on a computer. Compared to the on-line application, the desktop may not be platform independent, but may be customized to characteristics of a particular platform. So, such a customized application may be faster because it is optimized to run on particular hardware (e.g., specific graphics hardware, or dual displays).

In FIG. 4, the system includes seven modules and some databases or repositories. These modules can be implemented using software code, or in hardware, such as by firmware, or a combination or software and hardware. Some specific modules are shown, but a system may include a subset of the modules shown or additionally other modules (not shown). Also, some modules may be combined with other modules shown or different modules; for example, the import module may be combined with the risk module.

There is an administrative module 410, an import module 413, an assess module 416, a monitor module 419, a mitigate module 422, a prioritize module 425, and a risk module 440. An asset database 428 stores asset information. A security standards database 431 stores a repository of security standards.

There are arrows between the modules and databases. These arrows represent data pathways between the modules, so one module can pass data from one module to another module or from a module to a database, and vice versa. The data paths may be across a network (such as Ethernet or the Internet) or may be within a single computing machine or server, such as across buses or memory-to-memory or memory-to-hard-disk transfer. The data paths can also be representative of a module, being implemented as a subroutine, passing data in a data structure (e.g., variable, array, pointers, or other) to another module, which may be also implemented as a subroutine.

The modules represent how data and data processing procedures are organized in a specific system implementation, which facilitates the reporting and other features of the invention in an efficient and organized manner. Data can more quickly be accessed and drawn on the screen. System response time is fast and the user does not have do a lot of repetition to obtain the results the user desires.

More specifically, assets include anything of value to an organization. Assets include applications, support systems, programs, physical plans, systems (e.g., mission critical systems), and logically related groups of systems. Some specific examples of assets include servers, software applications, computers, networks, smartphones, offices, data storage rooms, and company cars—just to name a few examples. Information about these assets are stored in the asset database. In a particular implementation, assets are connected to or accessible via a network (e.g., Ethernet) of the information system. So, when an asset connects a network, the asset could pose a security concern because it may upload viruses or malware to other assets of the network. Or because the asset has no or minimal password controls, a hacker can use the new asset to gain access to the network and to other assets of the system (e.g., stealing credit card data available on a database of the network).

A standard or benchmark may be defined as an established norm or requirement. For example, a standard may establish engineering or technical criteria, methods, regulations, processes, recommendations, and practices. These are standards related to security of information systems. Some such standards are promulgated by government and various organizations such as the U.S. government, International Organization for Standardization (ISO), International Electrotechnical Commission (IEC), Information Systems Audit and Control Association (ISACA), IT Governance Institute (ITGI), National Institute of Standards and Technology (NIST), North American Electric Reliability Corporation (NERC), Information Security and Privacy Advisory Board, (ISPAB), and PCI Security Standards Council.

These bodies draft various standards, regulations, or both that describe, for example, requirements for security management, policies, and procedures (e.g., wireless encryption standards and back-up procedures). Other examples of regulations include Sarbanes-Oxley (SOX), Gramm-Leach-Bliley Act (GLBA), and Health Insurance Portability and Accountability Act (HIPAA).

An example of a standard is the ISO/IEC 27000-series (i.e., ISMS Family of Standards or ISO27k). This standard includes information security standards published jointly by the ISO and the IEC. The series provides practice recommendations on information security management, risks, and controls. The standard is provided at www.iso.org/iso/home.htm and is incorporated by reference.

In a specific implementation, a standard includes ISO 27001:2005. ISO 27001:2005 includes eleven security domains. Table A below lists these security domains and provides a brief description of each domain.

TABLE A

| | ISO Domain | Description |
|---|---|---|
| 1 | Information | The Security Policy defines essential requirements for security. |
| | Security Policy | The policy is intended to support management decisions and |
| | | explain the organization's security and IP position. |
| 2 | Security | Management support, security coordination, and security |
| | Organization | services alignment with business requirements and operations. |
| 3 | Asset Classification | Assets should be accounted for and categorized by risk. Then the |
| | and Control | relevance of each business process can be evaluated and |
| | | individual security requirements determined. |
| 4 | Human Resources | Security communication, training and awareness for employees, |
| | Security | contractors and other personnel. Includes background checks |
| | | and other controls to assess human risks. |
| 5 | Physical and | Controls required to protect assets from physical risks such as |
| | Environmental | theft and damage. |
| 6 | Communications | The security of operations and information exchange between |
| | and | organizations and staff as well as communication with external |
| | Operations | organizations. |
| | Management | |
| 7 | Access Control | Access to assets is modeled using appropriate access and |
| | | business roles concept. The appropriate technologies are then |
| | | implemented to enforce the model. |
| 8 | Systems | Integration of security into the system development lifecycle. |
| | Development and | Includes, security for change and configuration management. |
| | Maintenance | |
| 9 | Business | BCP (Business Continuity Planning) aims at uncovering risks |
| | Continuity | for the business process and defining emergency measures to |
| | Management | enable the organization to resume normal operations. |
| 10 | Security Incident | The establishment of people, process and technologies to ensure |
| | Response | that security incidents communicated in a manner allowing |
| | | timely corrective action to be taken. |
| 11 | Security | Identification and implementation of the appropriate actions |
| | Compliance | necessary to ensure requirements from legal, regulatory, and |
| | | other requirements are met. |

Generally, a standard, such as the ISO standard, is organized hierarchically. As an example, there can be a set of domains within the standard such as the domains listed in table A above. Within each domain there can be any number of subdomains. Within each subdomain there can be any number of components.

Other examples of standards include Control Objectives for Information and Related Technology (COBIT), PCI Data Security Standard (PCI DSS), and Payment Application Data Security Standard (PA-DSS). The security standards database stores one or more of these standards.

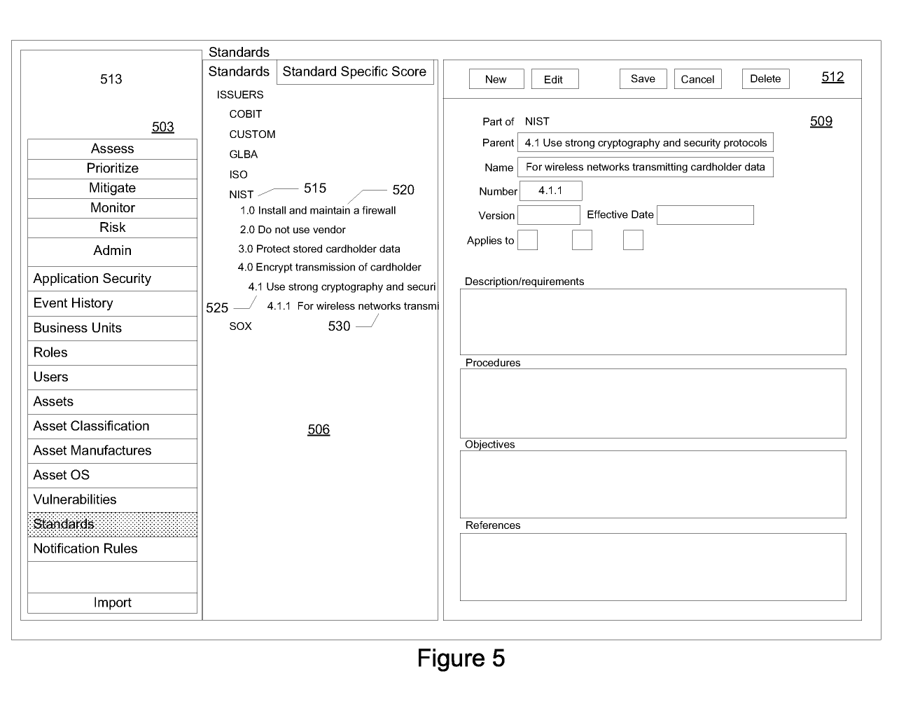

In a specific implementation, the administrative module provides an interface to the security standards database. The interface allows users to enter their own company-specific standards or procedures or modify an existing standard to tailor the standard to their organization. FIG. 5 shows a specific implementation of this interface. This interactive interface is displayed on a computer screen, in which the user can see information and select from various options (e.g., by a pointing device) made available in the interface. The user can also type in or input information in various text boxes.

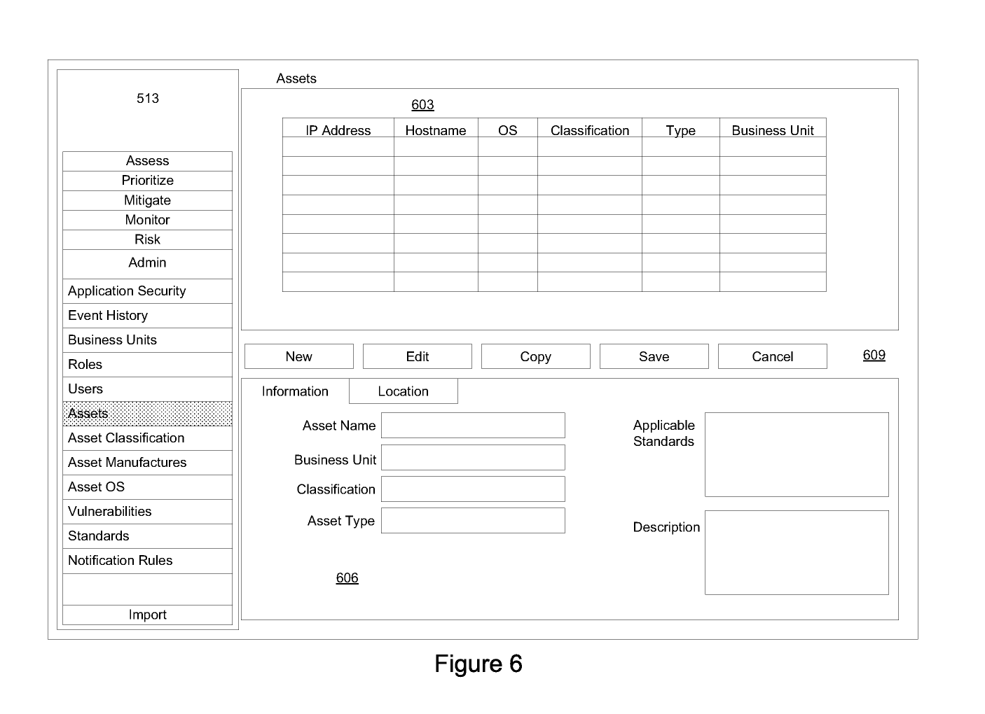

The administrative module also provides an interface to the assets database. The interface allows users to input and classify their assets. FIG. 6 shows a specific implementation of this interface.

Using the administrative module, users can also input vulnerabilities, import vulnerabilities discovered by a network enumerator (i.e., network scanner), or both. In a specific implementation, users can import vulnerabilities from a Qualys technical scan.

Furthermore, in a specific implementation, the import module provides an interface for the user to import a file that includes asset information. For example, via the import asset interface, the user can click a browse button, find the file to import, and upload the file to the system.

The assess module allows users to assess (i.e., measure, compare, or grade) their current procedures for protecting an asset against one or more standards. That is, via the assess module, users can examine assets gathered by the administrative and import modules. The users can compare the assets to one or more standards stored in the security standards database. Then, the users can decide, for example, whether their procedures to protect the asset are in compliance with the procedures described in the standard.

In a specific implementation, the system allows a user to create an assessment project. The assessment project can include any number of assessment plans, business units, assessment tasks, and users assigned to assessment tasks. There can be any number of assessment projects.

The assessment project allows users to evaluate the current status of their organization. The assessment project is based on one or more standards selected by the user. As discussed above, the user can select a predefined standard from the security standards database or import or customize their own standard. These standards include the measures by which the users will evaluate their organization.

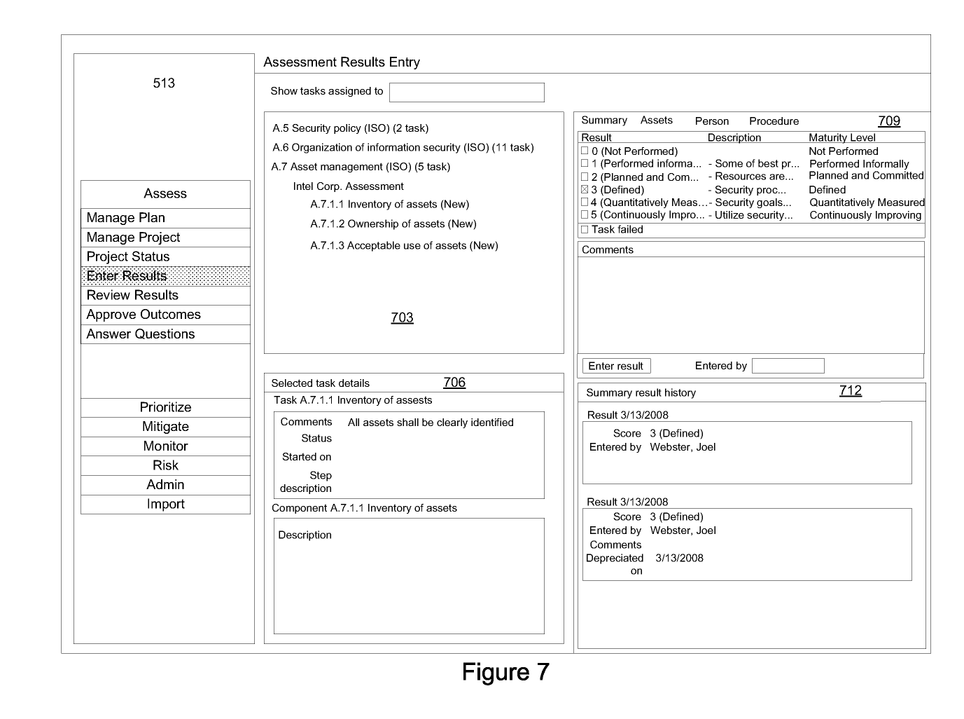

In a specific implementation, each component within a standard correlates to a task in the assessment project. Tasks may be assigned to people in the organization based on the roles they hold. Generally, task performers complete a survey for each task and submit the results via a Web interface or Web page. FIG. 7 shows a specific implementation of an interface to enter an assessment of an asset.

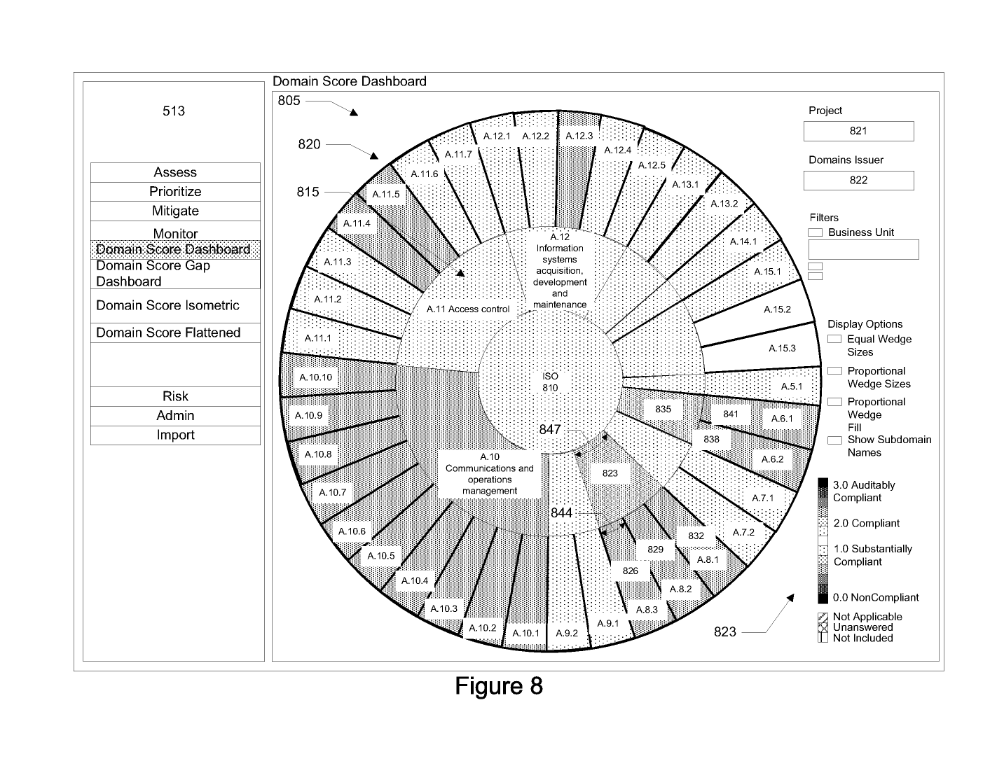

The monitor module provides summary information that indicates the company's performance with respect to a selected standard. A summary chart or wheel chart generated by the monitor module can provide a snapshot of the company's assessment results. FIGS. 8, 11, and 13 show specific examples of wheel charts.

Based on the assessment results, the company may decide to expend resources to bring current practices into compliance with a specific standard. Thus, the mitigate module allows users to create and track a mitigation project. The mitigation project can include any number of mitigation plans, business units, mitigation tasks, and users assigned to mitigation tasks. There can be any number of mitigation projects. In a specific implementation, mitigation tasks correspond to physical actions in the organization. Some examples of mitigation tasks include creating a firewall and documenting a specific procedure.

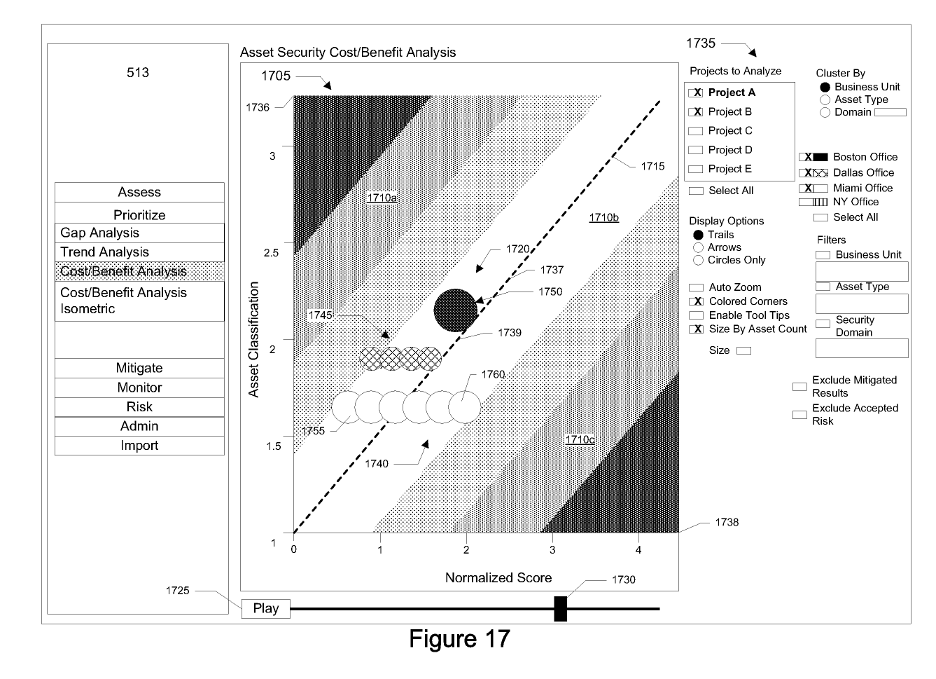

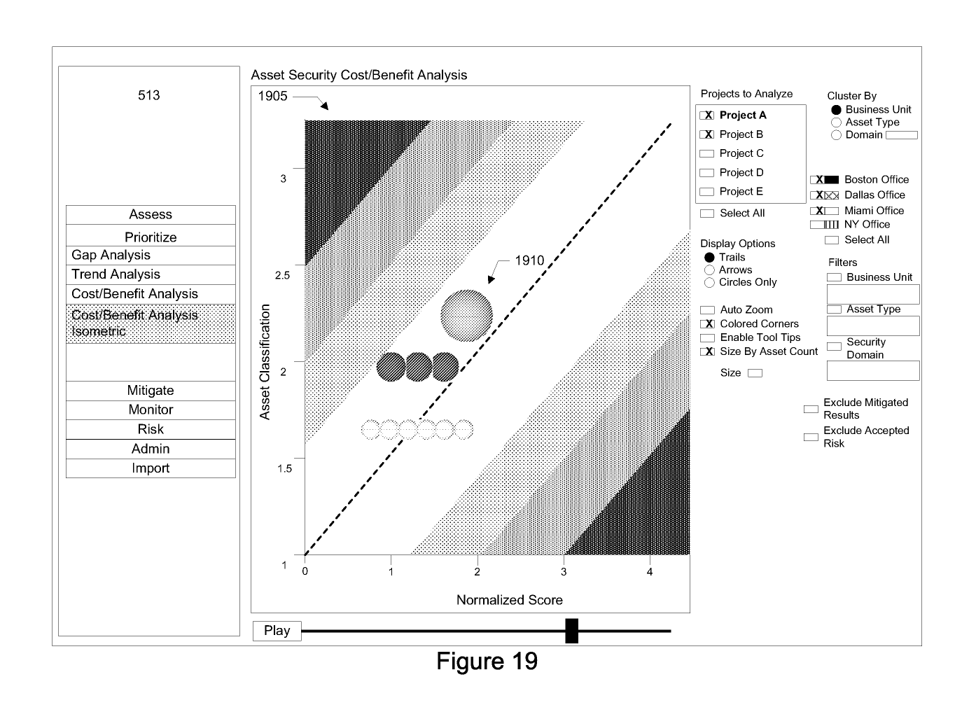

The prioritize module includes gap, trend, and cost/benefit analysis tools. A gap analysis chart or graph generated by the prioritize module allows the user to compare the company's actual performance with its potential or desired performance. The chart helps to provide the company with insight into areas (e.g., security areas) which could be improved. In a specific implementation, the prioritize module includes tools to generate trend analysis or cost/benefit analysis graphs. The cost/benefit analysis tool compares asset classifications and asset maturity levels. The tool generates a cost/benefit graph to help users determine whether they are spending too much or too little on specific assets, relative to the assets' importance or classification. FIGS. 17 and 19 show specific implementations of an asset security cost/benefit network security analysis trend tool.

The risk module provides tools to help the user identify risks, assess risks, and reduce risks. Risks can be defined as the probability of an event occurring multiplied by the impact of the occurrence. With the risk module, users can balance the operational and economic costs of protective measures. Users can identify areas or assets of their organization which have high risk and then allocate resources to reduce those risks.

The risk module consolidates the results and information from the assessment, mitigation, and other modules by asset so that the user can evaluate the likelihood (e.g. probability) and impact. Included in the assets' results can be information from third-party security products such as vulnerability scanners or anti-virus software. For example, the system can accept scanning information (e.g., technical scans) from Qualys, CVE, and Skybox. This information can be manually uploaded into the modules, integrated via regularly scheduled automatic uploads between networked systems, or both. For example, the information can be manually imported from an Excel file. The information can be automatically imported via a data feed (e.g., XML data feed).

In a specific implementation, the information includes a list of assets, an asset classification for each asset in the list of assets, a list of vulnerabilities, a vulnerability rating or scoring for each of the vulnerabilities in the list of vulnerabilities, or combinations of these. The vulnerabilities may be identified using any naming convention. In a specific implementation, the vulnerabilities are identified using the common vulnerabilities and exposures identifier or naming standard. The vulnerabilities may be rated using the common vulnerability scoring system (CVSS).

The risk module allows users to create what-if scenarios to see how changes or various inputs affect risk. For example, users can determine the impact of budget cuts and quantify how such budget cuts affect risk. Thus, the risk module can be used as a budgeting tool to forecast future risk.

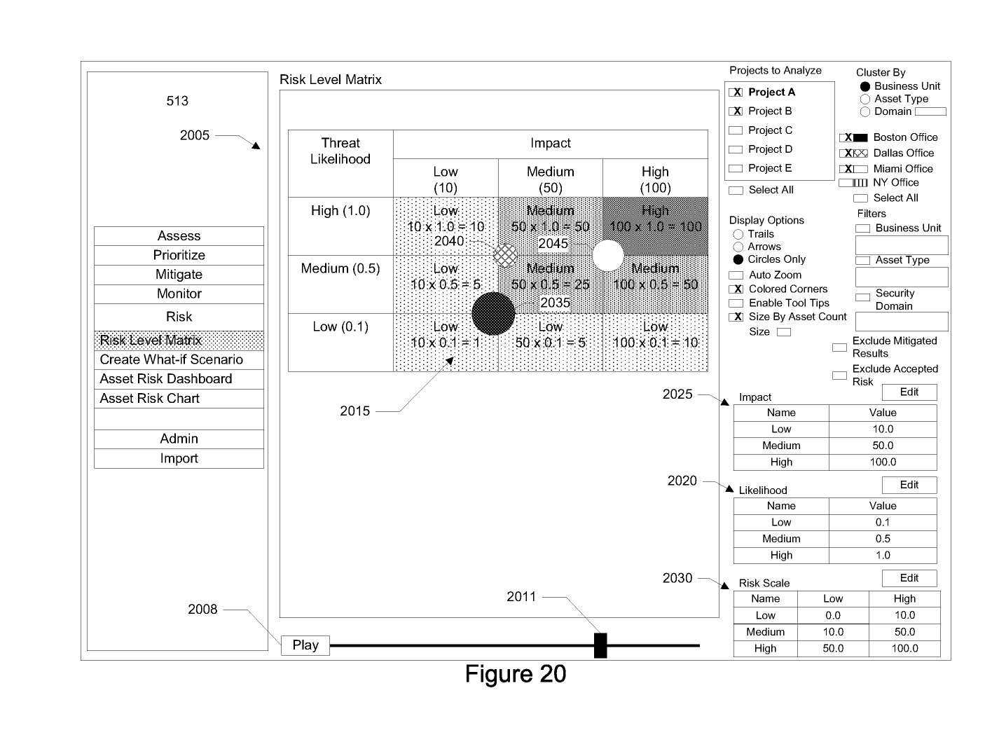

In a specific implementation, the risk module accepts as input asset and assessment information, including asset classifications. Users can customize the risk module by inputting the level of risk they are willing to tolerate. In other words, users can define their own risk threshold. The system then creates a risk level matrix that includes clusters of assets overlaid on the matrix. The position of the clusters indicates a risk score of the cluster. The matrix can be animated to show changes in risk score over time. FIG. 20 shows a specific implementation of a risk level matrix.

Further aspects of the system are described in U.S. provisional patent application 61/084,571, filed Jul. 29, 2008, which is incorporated by reference along with all other references cited in this application.

FIG. 5 shows a computer screen displaying a specific implementation of an application window to view, input, delete, edit (i.e., customize) standards information. This window is displayed when the user clicks the administrative module and selects a standards option. The application window includes a first portion (or panel) 503, a second portion 506, and a third portion 509. The second portion is between the first and third portions. A set of buttons 512 are above the third portion. As one of skill in the art would recognize, one or more of these portions can be implemented as panes that can be resized by the user (e.g., drag pane border to resize pane).

The first portion includes a menu 513 which shows a list of the modules such as the assess, prioritize, mitigate, monitor, risk, administrative, and import modules. Each module is displayed in a header section. The modules can be selected using, for example, a pointer to click a desired header section that lists the module. This expands the header section to show various links or options associated with the selected module. For example, clicking on a standards option in the administrative module displays standards information in the second and third portions.

Specifically, the second portion includes a list of one or more security standards. The one or more security standards are stored in the security standards database discussed above. In a specific implementation, the standards are displayed using a directory or folder tree (i.e., parent-child) interface or hierarchy. A first level 515 of the directory includes a standard (e.g., COBIT, CUSTOM, GLBA, ISO, NIST, PCI, and SOX). A second level 520 of the directory includes domains within the standard. A third level 525 of the directory includes subdomains within a domain. A fourth level 530 of the directory includes components within a subdomain. Users can expand and collapse the directory by, for example, clicking on the standards, domains, and subdomains.

The third portion displays detailed information of the domain (or subdomain) selected in the second portion. In this specific implementation, the third portion includes a parent node input box, a child node input box (or name), a version input box, an effective date of the standard, checkboxes to indicate whether the standard applies to assets, persons, procedures, or combinations of these. The third portion further includes a description or requirements input box which describes the standard, a procedures input box, an objectives input box, and a references input box.

The set of buttons allow the user to customize the various standards. The buttons include new, edit, save, cancel, and delete. The new button allows creating a new standard, domain, subdomain, component, or combinations of these. The edit button allows editing of an existing standard (e.g., edit the procedure for a specific subdomain within the standard). The save button saves the edits to the security standards database. The cancel button discards the edits. The delete button deletes a selected security standard, domain, subdomain, or component from the security standards database.

FIG. 6 shows a computer screen displaying a specific implementation of an application window to enter asset information to be saved in the assets database. This window is displayed when the user selects the administrative module from menu 513 then an assets option. The window includes a top or parent portion 603 and a bottom or child portion 606. A toolbar 609 is between the top and bottom portions.

The top portion includes a table. The table displays a list of the assets and various properties or attributes of each asset. In this specific implementation, an entry for an asset in the table includes an Internet Protocol (IP) address of the asset, a hostname, a name of an operating system associated with the asset, a service tag, a classification level of the asset, an asset type, and a business unit to which the asset belongs.

The bottom portion includes further information for the asset selected in the top portion such as a description of the asset and which security standards apply to the asset.

The toolbar includes buttons to create and edit assets. A new button allows the user to create a new asset. An edit button allows editing of an existing asset. A copy button allows copying of an existing asset. A save button saves the asset to the assets database. A cancel button cancels any changes made to an asset.

Generally, an organization or company can have any number of business units. The business units can be organized according to geographic location, product lines, business function, or combinations of these. Examples of geographic locations include cities (e.g., New York office and San Francisco office), and continents and countries (e.g., North America, Europe, and Asia). Examples of product lines include consumer products, industrial products, commercial products, and consulting services. Examples of business functions include marketing, development, and sales.

A business unit can have any number of assets. For example, a business unit can have tens, hundreds, thousands, or hundreds of thousands of assets. The system stores information that identifies to which business unit an asset belongs and information that identifies the number of assets a business unit has.

In a specific implementation, assets can be classified as high, medium, or low depending upon how critical the asset is to the organization or business unit. In this specific implementation, the asset classifications are mapped to numerical values (e.g., high=3, medium=2, low=1).

Thus, for any business unit, the system can perform various calculations and statistical analyses. For example, the system can calculate an average asset classification value of all the assets associated with a specific business unit. This value may then be stored (e.g., stored in a database).

Some examples of asset types include routers, switches, hubs, firewalls, servers, workstations, desktop computers, laptops, printers, smartphones, and wireless access devices.

The system can perform various calculations based on asset type. For example, the system can calculate an average asset classification value of all the assets of a specific asset type. The system can calculate an average asset classification value of all the assets of a specific asset type associated with a specific business unit. The system can then store these values.

An asset can be associated with one or more security standards or regulations (e.g., COBIT, GLBA, NIST, PCI, SOX). Thus, the system can perform various calculations based on which security standard an asset is associated with. For example, the system can determine the number of assets associated with a specific security standard. Calculate an average asset classification value of all the assets associated with a specific security standard.

FIG. 7 shows a computer screen displaying a specific implementation of an application window to input an evaluation of the asset. This window is displayed when the user selects the assess module from menu 513 then an enter results option. The window includes a first portion 703, a second portion 706 below the first portion, a third portion 709 adjacent to the first portion, and a fourth portion 712 adjacent to the second portion.

The first portion includes a listing or a partial listing of various security domains within a security standard. In a specific implementation, the security domains, subdomains, components, or combinations of these are mapped to tasks. The tasks are then assigned to one or more users to complete.

The second portion displays detailed information for the task (e.g., security domain) selected in the first portion. For example, a security domain selected in the first portion may be “inventory of assets.” The second portion may provide additional detail such as “all assets shall be clearly identified and an inventory of all important assets drawn up and maintained.”

The third portion includes input boxes for the user to evaluate, assess, or grade current practices. Specifically, the user can review or read the procedures described in the selected security domain (portions 703 and 706) and compare those procedures with their current procedures. In this specific implementation, the third portion includes a top portion and a bottom portion.

The top portion allows the user to assign a numerical score to current practices. In a specific implementation, the numerical score is used to identify or calculate the security maturity level of a business unit.

Table B below shows an example of scores that can be assigned.

TABLE B

| Score | Description |
|---|---|
| 0 | No security procedures are performed. |
| 1 | Procedures are performed informally. |
| 2 | Resources are planned and committed to performing the |
| | procedures. |
| 3 | Procedures are well-defined. Procedures are implemented in a |
| | consistent manner. |
| 4 | Security goals and objectives are quantitatively measured. |
| 5 | The business unit utilizes security metrics to make continuous |
| | improvements. |

Table B shows six possible scores that can be assigned. However, it should be appreciated that there can be any number of scores to assign. Furthermore, each score can have any numerical value.

The bottom portion allows the user to enter comments regarding current procedures. Such comments are stored in a database of the system.

The fourth portion displays history or tracking information. For example, assessments may be performed over a period of time. Each of these assessments is then saved by the system. This allows the system to perform historical or trend analyses. For example, the system can perform calculations indicating whether a business unit's security maturity has improved over a time period, has remained constant over the time period, or has worsened or decreased over the time period. This allows the user to prove the security return on investment to various other users (i.e., executives) in the organization.

In a specific implementation, the system instead or additionally sends out surveys (e.g., questionnaires) for users to complete. In this specific implementation, the surveys are in an electronic format (e.g., Web page displayed in a browser application window) for the users to complete. The system sends users or survey respondents an e-mail notification. The e-mail notification includes a link, such as a uniform resource locator (URL). Clicking on the link launches a browser application on the respondent's computer. The Web page survey is then displayed within a window of the browser application. After completing the survey, the respondent clicks a send button to send the responses back to the system. The responses are saved or stored for later statistical analysis of the responses.

Typically, the survey includes questions for the respondent to answer. The questions can be open-ended, closed-ended, or both. An open-ended question asks the respondent to formulate their own answer, whereas a closed a closed-ended question asks the respondent to pick an answer from a given number of options. An example of an open-ended question is: “Please list any barriers you are aware of that prevent developing a security awareness program to ensure personnel subject to the standard receive ongoing reinforcement in sound security practices.”

A close-ended question can be dichotomous (i.e., respondent has two options), nominal-polytomous (i.e., respondent has more than two unordered options), ordinal-polytomous (i.e., respondent has more than two ordered options), continuous (i.e., respondent is presented with a continuous scale), or combinations of these.

In a specific implementation, a close-ended question asks the respondent whether or not they agree with a statement. The respondent indicates their agreement (or disagreement) via a rating scale. In this specific implementation, the rating scale includes six options or radio buttons for the user to choose. The options include not applicable (i.e., N/A), strongly disagree, somewhat disagree, neutral, somewhat agree, and strongly agree. These options are mapped to numerical values. For example, the not applicable option is mapped to 0. The strongly disagree option is mapped to 1. The somewhat disagree option is mapped to 2. The neutral option is mapped to 3. The somewhat agree option is mapped to 4. The strongly agree option is mapped to 5. It should be appreciated that a rating scale can include any number of options for the user to chose. Furthermore, these options can be mapped to any numerical value.

An example of a statement on a survey is “we have an active program to create security awareness and promote ongoing reinforcement of sound security practices.” The system presents the respondent with the rating scale. The system then accepts the inputted rating.

In another implementation, the respondent is presented with a multiple choice question. That is, the respondent is asked to select one or more choices from a list. The selected choices may be scaled or adjusted to a specific rate or standard.

Thus, the system stores information concerning a specific security domain or procedure and information indicating how well the business unit is following or adhering to that specific security procedure. This allows the system to calculate various summary information. For example, for any given security domain the system can output a security maturity level score. In other words, the system can output an indication of whether respondents within a business unit feel that their business unit follows the procedures in that specific security domain.

FIG. 8 shows a computer screen displaying an application window showing a specific implementation of wheel chart 805. This window is displayed when the user selects the monitor module from menu 513 then a domain score dashboard option. The wheel chart includes a hub or circle 810 (i.e., issuer circle), a set of domain wedges 815 about the circle, and a set of subdomain wedges 820 about the circle. The domain wedges are between the circle and the subdomain wedges.

A project dropdown list 821 allows the user to select a project. A domains issue dropdown list 822 allows the user to select a standard to compare the project against. A compliance color legend 823 includes a set of discrete colors and a continuous color palette (i.e., color gradient, linear color gradient, color gradation, color spectrum, or color range).

Each domain can have any number of subdomains. For example, a first domain 823 includes first, second, and third subdomains 826, 829, and 832, respectively. A second domain 835 includes fourth and fifth subdomains 838 and 841, respectively. Each subdomain can have any number of associated components. In this specific implementation, as shown in the example of FIG. 8, these components are not displayed. In another implementation, these components are displayed.

A label attached to the hub identifies the standard (e.g., ISO). Labels attached to each of the wedges identify the specific domains or subdomains within the standard.

Each of the subdomain wedges has a subdomain sweep angle. For example, first subdomain 826 has a subdomain sweep angle 844. In a specific implementation, the subdomain sweep angles are the same for each of the subdomain wedges. In this specific implementation, the subdomain sweep angle is equal to 360 degrees divided by a total number of subdomains (e.g., total number of subdomains across all domains). In other words, the subdomain sweep angle (SDA) is given by the equation below.

$$SDA = \frac{360 degrees}{number of subdomains} \qquad ( 1 )$$

For example, if there are 38 total subdomains the subdomain sweep angle is about 9.5 degrees (i.e., 360 degrees/38 is 9.5 degrees) for each of the subdomain wedges. In this specific implementation, each of the subdomain wedges have the same size or sweep angle regardless of the number of components associated with a specific subdomain wedge.

In another implementation, the sweep angle of a subdomain wedge is proportional to a number of components associated with the subdomain wedge. In this specific implementation, the sweep angle of a subdomain is equal to 360 degrees times a number of components within the subdomain divided by a total number of components across all subdomains. In other words, the subdomain sweep angle is given by the equation below.

$$SDA = 360 degrees * ( \frac{number of components in subdomain}{\begin{matrix}total number of components \\ across all subdomains\end{matrix}} ) \qquad ( 2 )$$

Thus, in this specific implementation, subdomains having a greater number of components as compared to other subdomains will have a greater sweep angle than the other subdomains.

Each of the domain wedges has a domain sweep angle. For example, first domain 823 has a domain sweep angle 847. In a specific implementation, the domain sweep angle of a domain is proportionate to a number of subdomains associated with the domain—regardless of a number of components associated with the subdomains. In this specific implementation, the domain sweep angle for a domain is equal to a number of subdomains within the domain times a subdomain sweep angle of one of the subdomains in the domain. In other words, the domain sweep angle (DA) is given by the equation below.

DA=number of subdomains in domain*subdomain sweep angle (3)

In another implementation, the domain sweep angle of a domain varies proportionally with a number of components associated with the subdomains in the domain. In this specific implementation, the domain sweep angle of a domain is equal to 360 degrees times a total number of components in each subdomain of the domain divided by a total number of components in all subdomains. In other words, the domain sweep angle is given by the equation below.

$$DA = 360 degrees * ( \frac{\begin{matrix}total number of \\ components in domain\end{matrix}}{\begin{matrix}total number of \\ components across all domains\end{matrix}} ) \qquad ( 4 )$$

In a specific implementation, a first radius of the wheel chart is from a center of the circle to an outer edge of a subdomain. A second radius is from the center to an outer edge of a domain. The second radius is 67 percent of the first radius (i.e., second radius=0.67*first radius). A third radius is from the center to an edge of the circle. The third radius is 33 percent of the first radius (i.e., third radius=0.33*first radius).

In a specific implementation, one or more projects are associated with a standard. For example, the project may be an assessment project to assess or evaluate the assets of an organization. More specifically, project tasks are mapped to components within the standard. Users complete project tasks assigned to them by evaluating (e.g., scoring, grading, or assessing) their organization's or business unit's current procedures with respect to procedures described in the components. See FIG. 7. In some cases, only a portion of the components of a standard is included or associated with the project. A user, such as an administrative user, may exclude any number of components from evaluation for any number of reasons. For example, the administrative user may decide that the components are not applicable to the organization or the administrative user may decide to include the components in another project.

The wheel chart provides a user, such as a manager, a macro view of how the organization is doing. More specifically, the domains and subdomains of the wheel chart are color coded. In the figure, the different colors, shades, or hues are represented using different fill patterns.

The set of discrete colors of the color legend can include first, second, and third colors. The first color indicates that all the components within a domain or subdomain were scored or marked as not applicable. The second color indicates that all the components within the domain or subdomain were not included in the project. The third color indicates all the components within the domain or subdomain have not yet been evaluated by the users. That is, for each component in the domain or subdomain the users have not yet scored or measured their current procedures against the procedures described in the components of the standard.

The first color is different from the second and third colors. The second color is different from the third color. In a specific implementation, the first color is white. The second color is pale blue. The third color is light gray. However, it should be appreciated that any colors can be used. Furthermore, these colors and other colors described in this application can be configured by the user (i.e., user-configurable).

The continuous color palette of the color legend ranges from a fourth color to a fifth color to a sixth color to a seventh color. The fourth color indicates the domain or subdomain is fully compliant. The fifth color indicates the domain or subdomain is compliant. The sixth color indicates the domain or subdomain is substantially compliant. The seventh color indicates the domain or subdomain is noncompliant. Colors between the fourth and fifth colors, between the fifth and sixth colors, and between the sixth and seventh colors indicate varying degrees of compliance.

The colors provide the manager with an indication of how the organization's procedures measure along a spectrum of compliance (e.g., from auditably or fully compliant to compliant to substantially compliant to noncompliant).

In a specific implementation, the fourth color is different from the fifth, sixth, and seventh colors. The fifth color is different from the sixth and seventh color. The sixth color is different from the seventh color. In another implementation, two more colors are the same but have different hues. For example, the fourth and fifth color can be green, but the fourth color may be dark green and the fifth color may be light green.

In a specific implementation, the fourth color is dark green. The fifth color is light green. The sixth color is orange. The seventh color is dark red. The color on the continuous color palette progress from dark green to light green. The color then changes from light green to yellow to orange (i.e., the sixth color). Continuing down the color palette, the color changes from orange to dark orange to light red to red to dark red (i.e., the seventh color).

In a specific implementation, the system creates the continuous color palette by linearly interpolating the color components red, green, and blue.

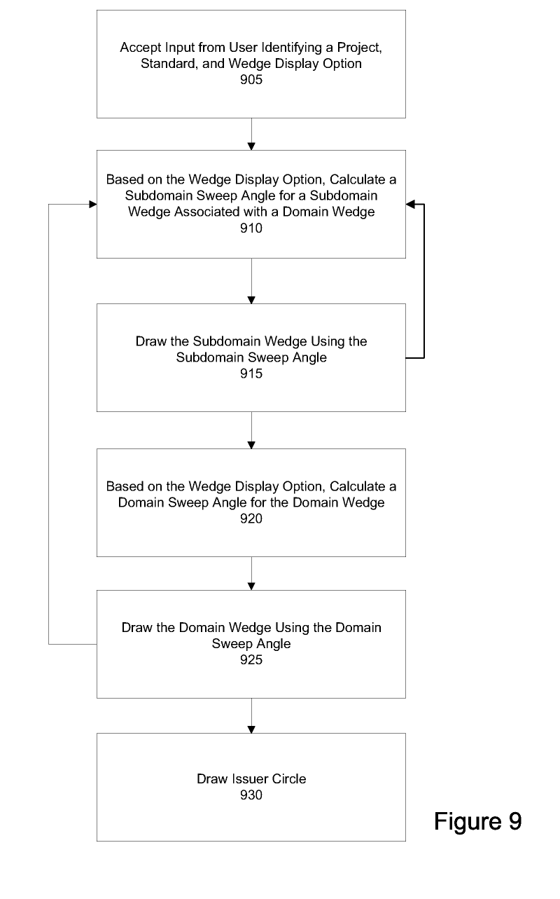

FIG. 9 shows a specific implementation of a flow diagram for drawing the wheel chart shown in FIG. 8. In a step 905 the system accepts input from the user identifying a project, standard, and wedge display option. A first wedge display option displays domain and subdomain wedges having sweep angles that are independent of a number of components associated with the domains and subdomains. A second wedge display option displays domain and subdomain wedges having sweep angles that are dependent on the number of components associated with the domains and subdomains.

In various other implementations, the input additionally includes information identifying one or more filters, one or more additional display options, or both. For example, the user may choose to exclude one or more selected business units, include one or more selected business units, exclude specific result types (e.g., exclude results with accepted risk or exclude mitigated results), or combinations of these. As another example, the user may choose to display proportional wedge fills. The user may choose to hide or not see subdomain labels, or to show or see subdomain labels.

In a step 910, based on the wedge display option, the system calculates a subdomain sweep angle for a subdomain wedge associated with a domain wedge. If the user selected the first wedge display option the subdomain sweep angle is calculated using equation (1) above. The system tallies (e.g., counts, sums, or determines) a number of subdomains within a domain. The subdomain sweep angle is calculated by dividing the number of subdomains into 360 degrees.

If the user selected the second wedge display option the subdomain sweep angle is calculated using equation (2) above. The system tallies a first number of components associated with a subdomain. The system tallies a second number of components associated with all subdomains of the standard. The first number is divided by the second number. The result is multiplied by 360 degrees to determine the subdomain sweep angle.

In a step 915 the system draws on a computer display the subdomain wedge using the subdomain sweep angle. Steps 910 and 915 are repeated for each of the subdomains associated with the domain.

In a step 920, based on the wedge display option, the system calculates a domain sweep angle for the domain wedge. If the user selected the first wedge display option the domain sweep angle is calculated using equation (3) above. The system tallies a number of subdomains within the domain. The system multiplies the sum by the domain sweep angle to find the domain sweep angle.

If the user selected the second wedge display option the domain sweep angle is calculated using equation (4) above. The system tallies a first number of components associated with the domain. The system tallies a second number of components associated with all domains of the standard. The first number is divided by the second number. The result is multiplied by 360 degrees to determine the domain sweep angle. The system then loops back to step 910 to perform a similar calculation for each of the remaining domains.

In a step 925, the system draws the domain wedge using the domain sweep angle. Steps 910-925 are repeated for each of the domains of the standard. In a step 930, the system draws the issuer circle or wheel hub. Generally, double-buffering is used to avoid flickering.

Table C below describes a specific flow for drawing the wheel chart.

TABLE C

| Step | Description |
|---|---|
| 1 | Accepting user selection of project to be graphed. |
| 2 | If the project includes multiple standard issuers, accepting user |
| | selection of desired standard issuer. Each standard issuer |
| | defines a set of domains, subdomains, and components as |
| | well as a set of scores. Each score is associated with a color. |
| | These colors are user-configurable. |
| 3 | Creating a continuous score color palette by linearly interpolating |
| | the color components red, green, and blue. |
| 4 | For each standard domain, determining the number of subdomains |
| 5 | For each subdomain, tallying the task results by result type and |
| | score; averaging the scored results. |

Table D below describes a specific flow for drawing or plotting equal size wedges.

TABLE D

| Step | Description |
|---|---|
| 1 | Defining a sweep angle of each wedge equal to 360 divided by a |
| | number of subdomains. |
| 2 | Drawing all subdomain wedges. The label is the subdomain |
| | number and name; the color is determined per above; the tooltip |
| | includes tally counts. The outer radius is the overall chart radius. |
| 3 | Drawing all domain wedges. The outer radius is 0.67 times an |
| | overall chart radius. The sweep angle of each equals the subdomain |
| | sweep angle times the number of subdomains. The color is |
| | determined as above where the task results include all |
| | subdomains. |
| 4 | Drawing the issuer circle (wheel hub). The radius is 0.33 times the |
| | overall chart radius. The label is the standard issuer name. |
| 5 | Using double-buffering to avoid flickering. |

Table E below describes a specific flow for drawing or plotting proportionally size wedges.

TABLE E

| Step | Description |
|---|---|
| 1 | Defining a subdomain wedge sweep angle as proportional to the |
| | number of components under that subdomain. The angle is 360 |
| | times a number of components in this subdomain divided by a |
| | number of components in all subdomains. |
| 2 | Defining a domain wedge sweep angle equal to 360 times a |
| | number of components in this domain divided by a number of |
| | components in all domains. |
| 3 | Drawing using the same sequence as above. |
| 4 | Using double-buffering to avoid flickering. |

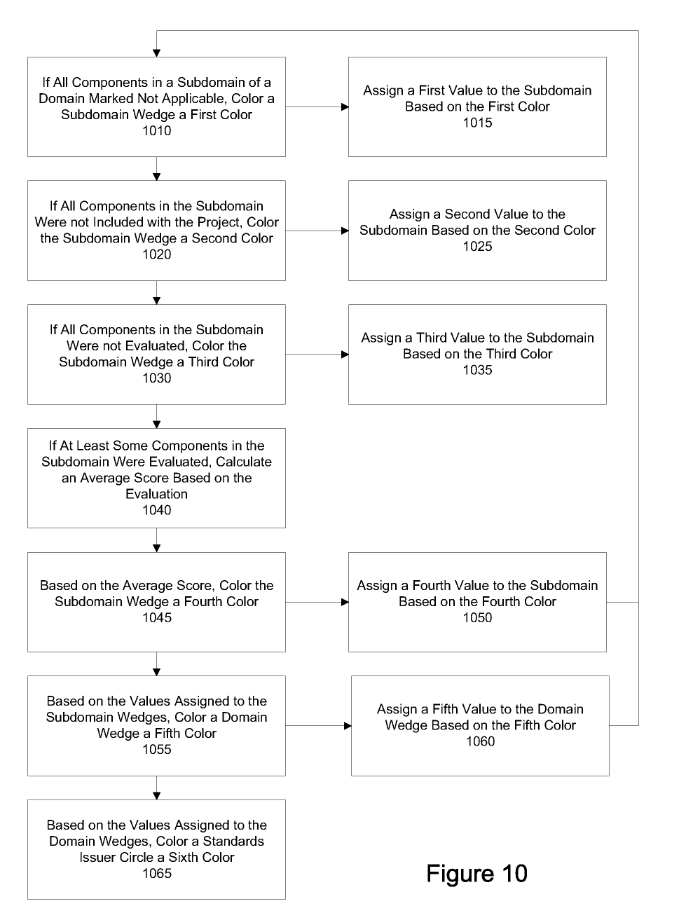

FIG. 10 shows a specific implementation of a flow diagram for coloring the wheel chart shown in FIG. 8. In a step 1010, if all components in a subdomain of a domain were marked not applicable, the system colors a subdomain wedge representing the subdomain a first color (e.g., white). For example, in a specific implementation, the subdomain includes a set of components. If each component in the set of components were marked not applicable, the system colors the subdomain wedge the first color. In a step 1015, the system assigns a first value to the subdomain based on the first color.

In a step 1020, if all components in the subdomain were not included in the project, the system colors the subdomain wedge a second color (e.g., pale blue). That is, if each component in the set of components were not included in the project, the system colors the subdomain wedge the second color. In a step 1025, the system assigns a second value to the subdomain based on the second color.

In a step 1030, if all components in the subdomain have yet to be evaluated by the users the system colors the subdomain wedge a third color (e.g., light gray). That is, if each component in the set of components were not included in the project, the system colors the subdomain wedge the third color. In a step 1035, the system assigns a third value to the subdomain based on the third color.

In a step 1040, if at least some of the components in the subdomain were evaluated, the system calculates an average score based on the evaluation. For example, during the evaluation, the user may have assigned a first score (e.g., 0) to a first component in the set of components. The score of 0 indicates that with respect to the first component there are currently no security procedures. The user may have assigned a second score (e.g., 1) to a second component. The score of 1 indicates that with respect to the second component procedures are performed informally. The user may have assigned a third score (e.g., 2) to a third component. The score of 2 indicates that with respect to the third component resources are planned and committed to performing the procedures described by the third component. Table B above lists other examples of scores that can be assigned.

In a specific implementation, the system calculates the average score by averaging the first, second, and third scores. In other words, the system sums the scores of components in a subdomain and divides the sum by a number of components within the subdomain.

In a specific implementation, other components in the set of components that were marked not applicable, not included in the project, or not yet evaluated are not included in calculating the average score. In another implementation, one or more of these components may be included in calculating the average score. The one or more components may or may not be given equal weight in calculating the average score. For example, these one or more components may be weighted differently from the components which were scored to calculate a weighted average or mean.

In a step 1045, based on the average score, the system colors the subdomain wedge a fourth color. In a specific implementation, the system stores a color table. Each color in the color table is associated with a reference number. The system selects the fourth color by comparing the average score with the reference numbers. If there is a match between the average score and the reference number the system selects the color (i.e., fourth color) from the color table that is associated with the matching reference number.

If there is not a match the system uses a linear interpolation technique between two colors of the color table to determine the fourth color. In other words, the fourth color will be an intermediate color between the two colors. As an example, a first reference number of the color table is associated with the color red. A second reference number is associated with the color yellow. If the average score is between the first and second reference numbers the fourth color will be a red-yellow mix. More specifically, if the average score is closer to the first reference number than the second reference number, the fourth color will have more red than yellow. Conversely, if the average score is closer to the second reference number than the first reference number, the fourth color will have more yellow than red.

In a step 1050, the system assigns a fourth value to the subdomain based on the fourth color.

The system then loops back to step 1010 and repeats steps 1010-1050 for each of the remaining subdomains in the domain.

In a step 1055, based on the values assigned to the subdomain wedges (e.g., first, second, third, or fourth values), the system colors a domain wedge representing the domain a fifth color. In a specific implementation, the system calculates an average subdomain value using the values assigned to each of the subdomains of the domain. The average subdomain value is then used to select a color or a combination of colors from the color table for the domain wedge. A technique to select the color may be the same as the technique used in step 1045.

In a step 1060, the system assigns a fifth value to the domain wedge based on the fifth color. The system then repeats steps 1010-1060 for each of the remaining domain wedges of the standard.

In a step 1065, based on the values assigned to the domains (e.g., fifth values), the system colors the standards issuer circle of the wheel chart a sixth color. In a specific implementation, the system calculates an average domain value using the values assigned to each of the domains of the standard. The average domain value is then used to select a color or a combination of the colors from the color table for the issuer circle. A technique to select the color may be the same as the technique used in step 1045.

Table F below describes a specific flow for coloring the wheel chart.

TABLE F

| Step | Description |
|---|---|
| 1 | If all components were answered “not applicable,” coloring the |
| | wedge white. |
| 2 | If none of the components were included in the project, coloring |
| | the wedge pale blue. |
| 3 | If none of the components were answered, coloring the wedge |
| | light gray. |
| 4 | If some components were scored, determining the color from the |
| | standard score colors. A continuous color palette is determined by |
| | interpolating between the standard score colors. |

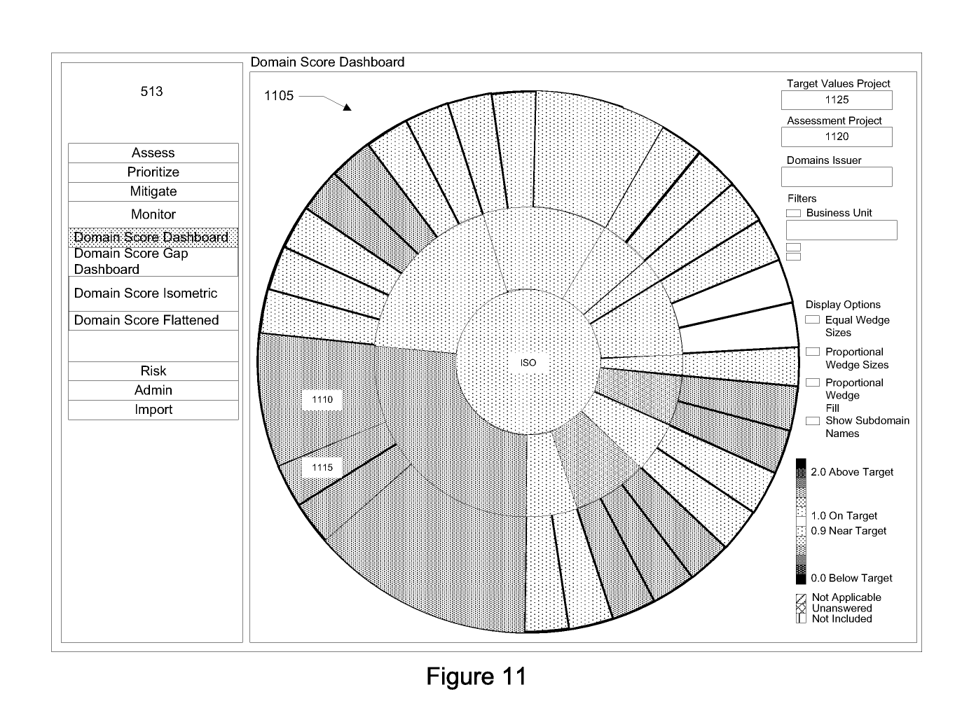

FIG. 11 shows a computer screen displaying an application window showing another implementation of a wheel chart 1105. This wheel chart is similar to the wheel chart shown in FIG. 8, but this wheel chart shows subdomain wedges displayed in proportion with the number of components associated with a specific subdomain wedge. In other words, the subdomain sweep angle of a subdomain is proportionate to the number of components in the subdomain. For example, a first subdomain wedge 1110 includes a greater number of components than a second subdomain wedge 1115. Thus, as shown the figure, the subdomain sweep angle of the first subdomain wedge is greater than the subdomain sweep angle of the second subdomain wedge.

Furthermore, wheel chart 1105 compares two different projects. In other words, there is an assessment project 1120 and a target project 1125. In a specific implementation, both projects are based on the same standard. Using the system, the user creates the target project. The target project includes one or more components of the standard. Within the target project the user can set specific targets or maturity target levels for the one or more components that the user would like their organization or business unit to meet. As an example, for a first component the user can set a first target. For a second component, the user can set a second target, different from the first target.

The assessment project includes an assessment of the one or more components. For example, the first component may be assessed a first score. The second component may be assessed a second score. The system can then compare the assessment and target projects. More specifically, for the first component the system can compare the first score to the first target. Similarly, for the second component the system can compare the second score to the second target.

The system can then graphically show whether or not these targets have been meet. The system can graphically show the gap between the score and the target, i.e., show an indication of how close the score is to the target. In a specific implementation, the colors on the graph represent gaps between a desired score and an actual score.

Thus, the user can create a first project (i.e., target project), select one or more components of a standard to include in the first project, and set target values (i.e., security maturity target levels) for the one or more components. The user can create a second project (i.e., assessment project), include the one or more components, and assess (i.e., score) the one or more components. The first and second projects can be compared. The system can graphically show differences, the degree of difference, or both between the score and the target values of the one or more components with respect to the domains and subdomains to which the one or more components belong.

When creating the target project, the user can decide which of the included components have a high importance and which have a low importance. For the components with the high importance the user can set high target maturity levels. For the components with the low importance the user can set low target maturity levels. This allows the user to make better decisions on where to focus resources.

Similar to FIG. 8, the domain and subdomain wedges of the wheel chart are color coded. In particular, the colors, which are indicated by different fill patterns in FIG. 11, are used to indicate, for example, whether specific domains and subdomains in the assessment project are above target, on target, near target, or below target as compared to the target project. A technique used to draw and color the wheel chart may be similar to the techniques shown in the flow diagrams of FIGS. 9-10 and discussed above.

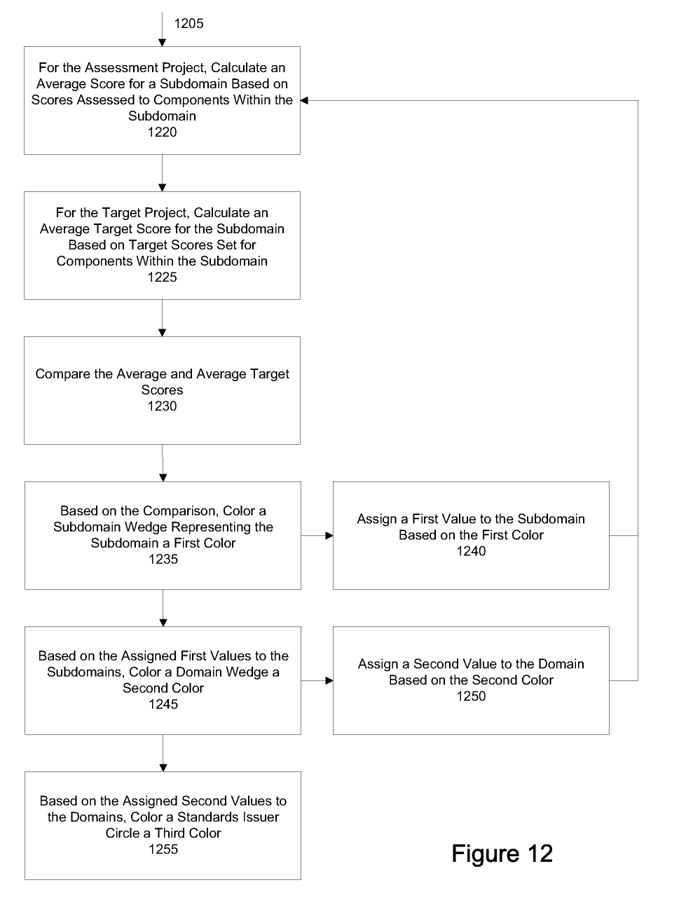

FIG. 12 shows a flow diagram to color wheel chart 1105 after the wheel chart is drawn via, for example, the technique described in steps 1010-1030 in FIG. 10. An arrow 1205 indicates at least some components within a subdomain of an assessment project were evaluated or scored. In a step 1220, for the assessment project, the system calculates an average score for the subdomain based on scores assessed to the components within the subdomain.

In a step 1225, for the target project, the system calculates an average target score for the subdomain based on target scores set for the components within the subdomain.

In a step 1230, the system compares the average and average target scores. The comparison may include calculating a ratio of the average score to the target score, calculating a ratio of the target score to the average score, determining a difference between the average score and the target score, determining a difference between the target score and the average score, determining whether the average score is greater than, less than, or equal to the target score, determining whether the target score is greater than, less than, or equal to the average score, scaling the scores, or combinations of these.

In a step 1235, based on the comparison, the system colors a subdomain wedge representing the subdomain a first color. In a specific implementation, the first color is selected using the linear interpolation technique discussed in step 1045 above. In a step 1240, the system assigns a first value to the subdomain based on the first color.

Steps 1220-1240 are then repeated for each of the subdomains in a domain.

In a step 1245, based on the first values assigned to the subdomains, the system colors a domain wedge representing the domain a second color. In a specific implementation, a technique to color the domain wedge is similar to the technique discussed in step 1055 above.

In a step 1250, the system assigns a second value to the domain based on the second color. Steps 1220-1250 are then repeated for each of the remaining domains of the standard.

In a step 1255, based on the second values assigned to the domains, the system colors a standards issuer circle of the wheel chart a third color. In a specific implementation, a technique to color the standards issue circle is similar to the technique discussed in step 1065 above.

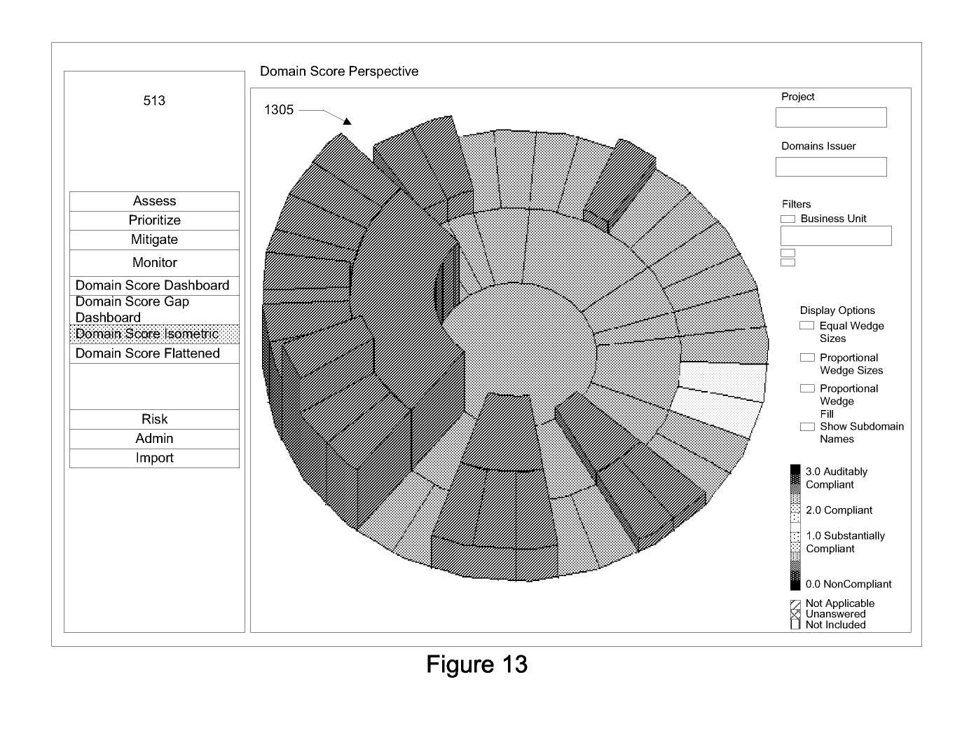

FIG. 13 shows a computer screen displaying an application window showing a specific implementation of an isometric or perspective rendering (e.g., 3-D) wheel chart 1305. This window is displayed when the user selects the monitor module from menu 513 and then a domain score isometric option. In this specific implementation, one or more wheel chart wedges has a specific height. The height can be positive (e.g., wedge appears to project out of the screen) or negative (e.g., wedge appears to project into the screen). The height of the wheel chart wedges indicate values or measurements of a variable. A wedge height can vary proportionally with respect to the variable. For example, as the variable increases the wedge height increases. The wedge height can vary inversely with respect to the variable. For example, as the variable increases the wedge height decreases.

In a specific implementation, the variable includes a measure of risk such as a probability or likelihood that an event (e.g., security breach) will occur. In this specific implementation, the heights of the wheel chart wedges vary proportionally with respect to the probability of an event occurring. Thus, a first wedge of a first domain having a first height, greater than a second height of a second wedge of a second domain, indicates a security breach is more likely for the first domain than the second domain.

In another implementation, the variable includes a measure of cost. The height of a security domain (or subdomain) can indicate the amount of money budgeted or allocated to the domain, an expenditure rate of resources spent on the domain, the amount of a cost overrun, the amount of money actually spent on the security domain, the amount of money projected to be spent on the security domain, and so forth.

However, it should be appreciated that the variable can include any business metric, financial metric, security metric, performance metric, or other performance indicator, or combinations of these. Thus, in various implementations, the variable represents revenue, security costs, volume of network data, or any other measurement that the user chooses to graph.

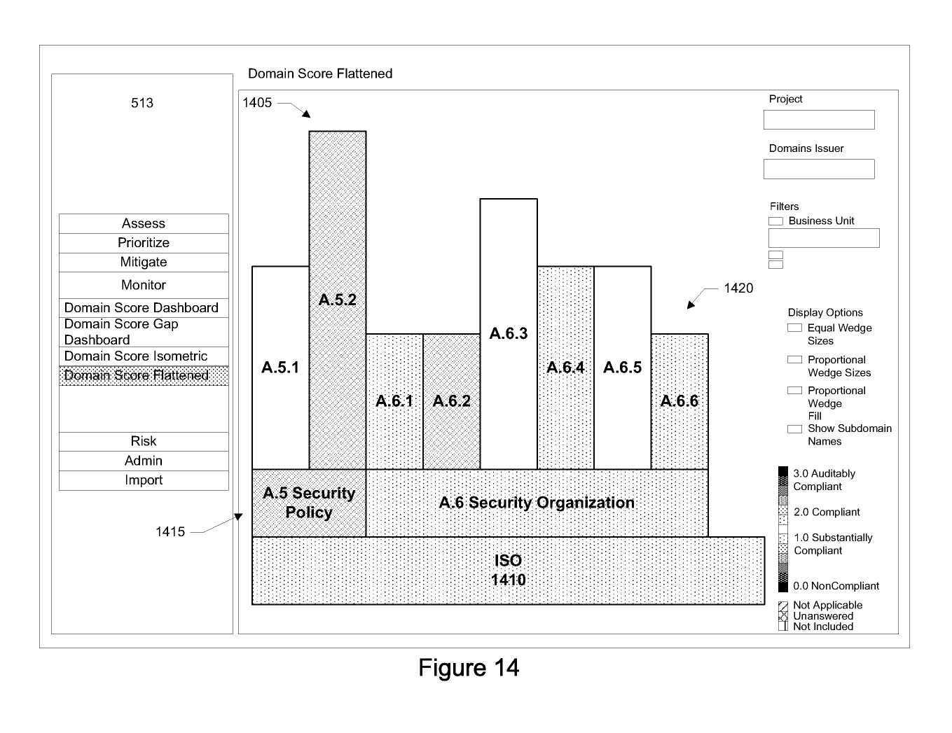

FIG. 14 shows a computer screen displaying an application window showing a specific implementation of a flattened wheel chart 1405. This window is displayed when the user selects the monitor module from menu 513 and then a domain score flattened option. This wheel chart is similar to the wheel chart shown in FIG. 13, but is displayed without the isometric rendering. A first or bottom layer 1410 of the chart represents a security standard (e.g., ISO). A second layer 1415 of the chart represents domains within the security standard. A third layer 1420 of the chart represents subdomains within each of the domains.

In this specific implementation, the height of a subdomain indicates the measurement of the variable.

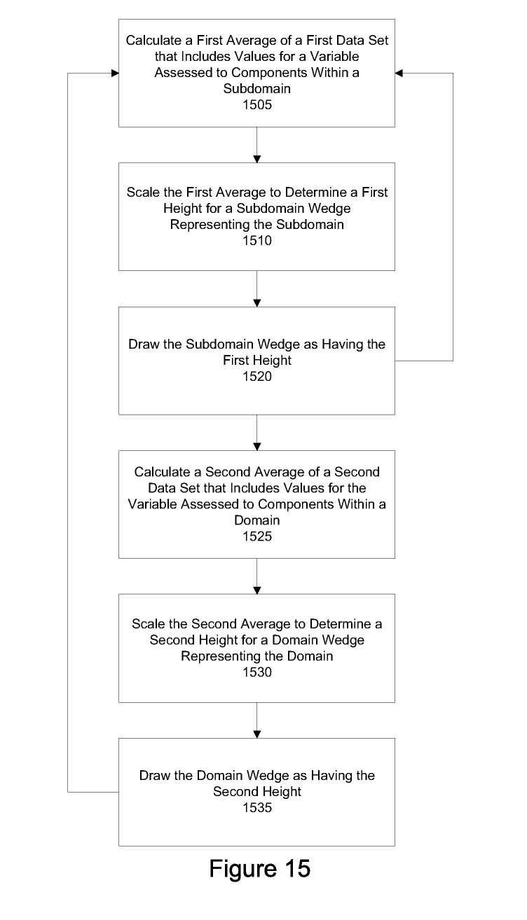

FIG. 15 shows a specific implementation of a flow diagram for drawing an isometric wheel chart. This specific implementation includes steps similar to the steps shown in FIGS. 9 and 10 for drawing and coloring a 2-D (two dimensional) wheel chart.

In a step 1505, the system calculates a first average of a first data set. The first data set includes values for a variable (e.g., risk) assessed to components within a subdomain. In a step 1510, the system scales the first average to determine a first height for a subdomain wedge representing the subdomain. In a step 1520, the system draws the subdomain wedge as having the first height. The system repeats steps 1505-1520 for each of the subdomains within a domain.

In a step 1525, the system calculates a second average of a second data set. The second data set includes values for the variable assessed to components within the domain. In a step 1530, the system scales the second average to determine a second height for a domain wedge representing the domain. In a step 1535, the system draws the domain wedge as having the second height. The system repeats steps 1505-1535 for each of the remaining domains of the standard.

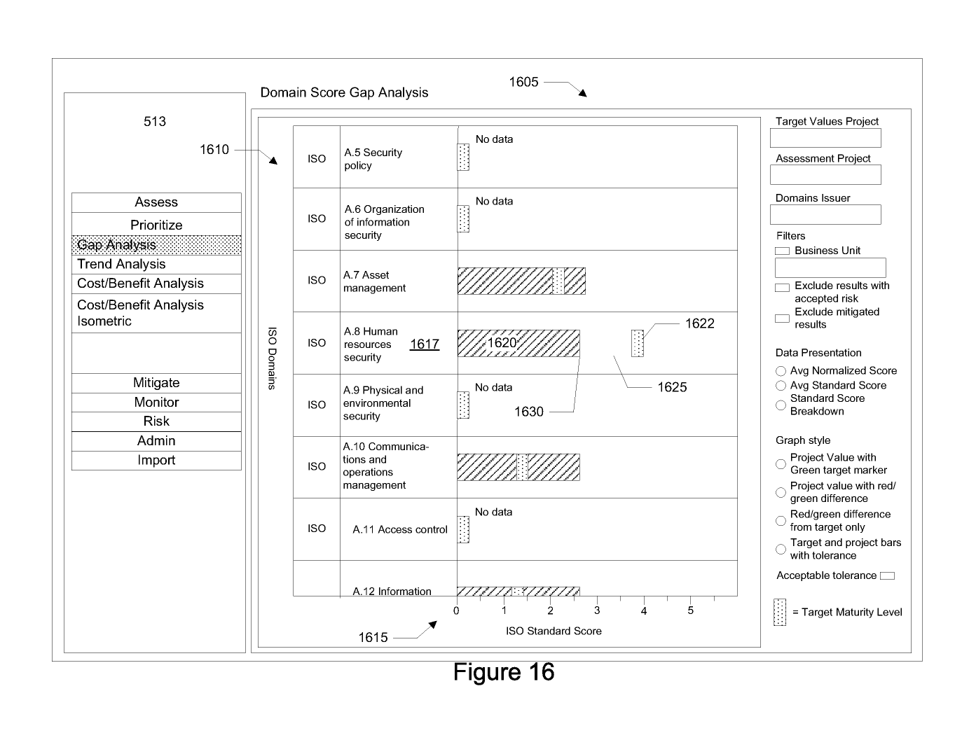

FIG. 16 shows a computer screen displaying an application window showing a specific implementation of a gap analysis chart (e.g., gap analysis bar chart) 1605. This window is displayed when the user selects the prioritize module from menu 513 and then a gap analysis option. The chart includes a list of domains 1610 along a y-axis of the chart and a security maturity measurement 1615 along an x-axis of the chart.

The security maturity of a domain, such as a domain 1617, is graphically represented by, a bar 1620. A target indicator 1622 indicates a desired security maturity for the domain. The desired security maturity can be set by the user. A gap, such as a gap 1625, indicates a difference between the desired security maturity of the domain and a current security maturity 1630 of the domain.

FIG. 17 shows a computer screen displaying an application window showing a specific implementation of a network security analysis trend tool 1705. This window is displayed when the user selects the prioritize module and then a cost/benefit analysis option.

In this specific implementation, asset classification is measured along a y-axis of the tool (e.g., chart or graph). Security maturity is measured along an x-axis which is perpendicular to the y-axis. Thus, in this specific implementation, neither the x-axis nor the y-axis includes a measurement of time. Rather, in this specific implementation, y-axis includes a range of asset classifications and the x-axis includes a range of security maturity scores. The range of scores may be normalized. The x and y axes can be swapped. For example, the y-axis can include the range of security maturity scores and the x-axis can include the range of asset classifications. Furthermore, in other implementations, the x-axis, y-axis, or both can include a measure of time.

The tool includes first, second, and third regions 1710a, 1710b, and 1710c and a reference line 1715 overlaying the tool. Shapes 1720 indicate clusters of a clustering type (e.g., business unit, asset type, and security domain type). There is a play button 1725 at a bottom of the tool and a slider 1730. A set of options 1735 adjacent to the tool allows the user to select various options for what to display in the tool.

In a specific implementation, the reference line is drawn at a 45-degree angle to the x and y axes and passes through an origin or an intersection of the x and y axes. In this specific implementation, the reference line is defined by the equation y=m×+b, where m is the slope of the reference line and is equal to 1 and x=y.

However, the reference line can be at any angle to the x or y axes. For example, the reference line can be at a 15, 20, 30, 45, or 60-degree angle to the x-axis or y-axis. Furthermore, the reference line need not pass through the intersection of the x and y axes. The reference line can be a horizontal line (e.g., having a zero slope). The reference line can be a vertical line (e.g., having an undefined slope). The position of the reference line may be user-defined, based on user input, or both.

Furthermore, the reference line is not necessarily a straight line. For example, the reference line may be curved line (i.e., a line having one or more curves). The reference line may be defined by a quadratic function, an exponential function, or another other function.

In a specific implementation, the reference line is colored green, but can be colored using any color (e.g., red, blue, orange, black, purple, or yellow). The reference line can have a solid or dotted (i.e., dashed) line pattern.

There can be any number of reference lines. Thus, although FIG. 17 shows one reference line, various other implementations include more than one reference line (e.g., two or more reference lines, three reference lines, or four reference lines).

In a specific implementation, the first region includes a first color gradient (or linear color gradient). The first color gradient includes a first color at a first point 1736 and a second color at a second point 1737. A first line passes through the first and second points. Colors along the first line are calculated using linear interpolation and extend perpendicular to the first line. These colors are indicated in the figure using various fill patterns. In this specific implementation, the first line is perpendicular to the reference line, the first point is at a maximum asset classification value on the y-axis, and the second point is at a first intersection of the first line and the reference line.

In this specific implementation, the first color is red and the second color is white. Thus, colors along the first line from the first point to the second point progress from red to a lighter red. Eventually, the color becomes white at the second point. The red color indicates a region of excessive risk.

The second region includes a second color gradient. The second color gradient includes a third color at a third point 1738 and a fourth color at a fourth point 1739. A second line passes through the third and fourth points. Similar to the first color gradient, colors along the second line are calculated using linear interpolation and extend perpendicular to the second line. In this specific implementation, the second line is perpendicular to the reference line, the third point is at a maximum security score on the x-axis, and the fourth point is at a second intersection of the second line and the reference line.

In this specific implementation, the third color is yellow and the fourth color is white. Thus, colors along the second line from the third point to the fourth point progress from yellow to a lighter yellow. Eventually the color becomes white at the fourth point. The yellow color indicates a region of excess security, in relation to the value of the asset(s).

Various pieces of text may overlay the tool or graph. This text may identify the various regions. For example, in a specific implementation, a first text including the phrase “insufficient security” overlays the first region. The first text is positioned at or near the first point. That is, the first text is positioned in an upper left-hand corner of the first region. A second text including the phrase “excessive security” overlays the second region. The second text is positioned at or near the third point. That is, the second text is positioned in a lower right-hand corner of the second region. A third text including the phrase “optimal balance” is positioned along the reference line.

In a specific implementation, the slopes of the first and second lines are equal. In another implementation, the slopes are different. The first and second intersections may be the same or different. Furthermore, it should be appreciated that the first, second, third, and fourth colors can be any color (e.g., blue, green, orange, purple, or pink).

In a specific implementation, shapes of the first and second regions are symmetric or are mirror images of each other. In this specific implementation, the reference line is an axis of symmetry such that a shape defining the first region on one side of the axis is a mirror image of a shape defining the second region on another side of the axis.

The shape defining the first region, second region, or both may be a triangle as shown in the example of FIG. 17. The triangle may be a right-triangle such as a 45-45-90-degree triangle, a 30-60-90-degree triangle, or any other right-triangle.

In this specific implementation, a shape defining the first and second region is a right-triangle. A hypotenuse of the right-triangle is parallel with the reference line. A distance from a first hypotenuse of a first right-triangle defining the first region is the same as a distance from a second hypotenuse of a second right-triangle defining the second region.

However, the first region, second region, or both can be defined by any shape (e.g., rectangle or box). Furthermore, shapes defining the first and second region may not be mirror images of each other.

Areas of the first and second region can be the same or different. For example, an area of the first region can be the same as an area of the second region. The area of the first region can be different from the area of the second region. The area of the first region can be greater than the area of the second region. The area of the second region can be greater than the area of the first region.

Users can define the first and second regions. That is, users can define the colors for the first and second regions, the rate at which the colors change, the direction in which the colors change, areas of the first and second regions, or combinations of these.

Thus, one company can have thresholds or tolerance levels that are different when compared to another company. This ability to customize allows the user to graph and analyze data in a manner that makes sense for the company. For example, some companies may not agree that having too much security is a bad thing, therefore they may make the yellow area smaller, while making the red area bigger.

In a specific implementation, shapes 1720 are circles or bubbles, but can be squares, rectangles, stars, ovals, triangles, or any other shape. The shapes may instead or additionally include icons, pictures, graphics, images, or combinations of these.

In this specific implementation, the shapes indicate clusters of a clustering type selected by the user. Some examples of clustering types include business unit, asset type, and security domain type. In a specific implementation, the clusters include or represent groups of assets. A cluster can include any number of assets. Thus, clustering by business type groups (i.e., clusters) the assets by business type; clustering by asset type groups the assets by asset type; and clustering by security domain groups the asset by security domain type.

The shapes can be color coded. In a specific implementation, the colors represent specific entities within a selected cluster type. If the user selects the business unit clustering type, the shape colors will represent specific business units. For example, purple bubbles may represent the Boston office or business unit. Brown bubbles may represent the Dallas business unit. Blue bubbles may represent the New York business unit, and so forth. As another example, if the user selects the asset type clustering type, the shape colors will represent specific asset types (e.g., routers, switches, hubs, firewalls, servers, and workstations). If the user selects the security domain clustering type, the shape colors will represent specific security domain types. Some examples of security domain types are shown in table A above.

As shown in the example of FIG. 17, there is a first set of clusters 1740 of a clustering type, a second set of clusters 1745 of the clustering type, and a third set of clusters 1750 of the clustering type.

In this specific implementation, the sets of clusters indicate trending either towards the reference line or away from the reference line. In this specific implementation, the reference line indicates a desired (e.g., optimal) balance or trade-off between cost and benefit, i.e., the cost of protecting an asset versus the asset's benefit. The play button animates the tool to show the movement of the clusters over time. The slider can be dragged back and forth (e.g., dragged using a pointer) to rewind or fast forward through the animation.

Thus, the first region, second region, and reference line can provide an indication of a desirable (or an undesirable) position or location of the clusters. For example, a small distance between a cluster and the reference line indicates that a business unit is making a good trade-off between the cost of protecting assets in the business unit and the benefits of the assets. A large distance between the cluster and the reference line indicates that the business unit is making a poor trade-off. Depending on whether the cluster is positioned in the first region or the second region, the business unit should spend more or less resources in protecting those assets.

For example, clusters of assets located in an upper left-hand corner of the tool indicate that these assets have a high classification value, but have low security maturity scores. Therefore, resources should be expended to improve the security of these assets. The improving security scores of these assets can be shown in the tool as the clusters of assets move towards the reference line. Clusters of assets located in a bottom right-hand corner of the tool indicate that these assets have a low classification value, but have high security maturity scores. Therefore, resources should be shifted to protecting other assets such as those assets having the high asset classification and low security score. Thus, the tool can be used to prove security return on investment. That is, the tool can be used to demonstrate over time the economic value of implementing security projects and activities. In particular, the tool can be used to demonstrate the judicious use of resources in implementing security projects and activities.

The clusters show trends from one project to another project. The clusters are associated with projects. For example, a first and second project may be associated with the first, second, and third cluster sets. In particular, a first circle 1755 in the first set of clusters may be associated with the first project. The first project indicates a first state of average asset classifications and average security scores at a first time. A second circle 1760 in the first set of clusters may be associated with a second project. The second project indicates a second state of average asset classifications and average security scores at a second time, different from the first time. For example, the first time may be after the second time.

When the user clicks the play button, the first circle, which is associated with the first project, is drawn. The first circle has x and y coordinates that indicate an average security score and classification of the assets, respectively, at the first time.

As the play continues, the second circle, which is associated with the second project, is drawn. The second circle has x and y coordinates that indicate an average security score and classification of the assets, respectively, at the second time.

The overlapping circles between the first and second circles may be referred to as trails. In a specific implementation, a path of the trails is determined by linearly interpolating between the positions of two circles (i.e., between the first and second circles). Displaying the trails is optional. That is, the user can choose to display or not display the trails. The user may instead choose to display arrows between the first and second circles to indicate a trending direction. The user may instead to choose to hide both the trails and arrows.

In a specific implementation, circles associated with a project (e.g., first and second circles) can be clicked on for more information. In this specific implementation, these clickable circles are visibly distinguishable from the trail circles.

In a specific implementation, a size or diameter of a circle varies in proportion with a number of assets associated with the circle. It should be appreciated that a circle or bubble may instead or additionally represent variables such as revenue, security costs, volume of network data, or any other measurement that the user chooses to graph.

Thus, in a specific implementation, the bubbles move, because there are many assessments performed on the same assets over a period of time (e.g., over the course of N number of years). The network security analysis trend tool or animated graph shows how the assets, when grouped by business unit or other category change in terms of their importance (asset classification) as related to the level of security controls (average assessment results).

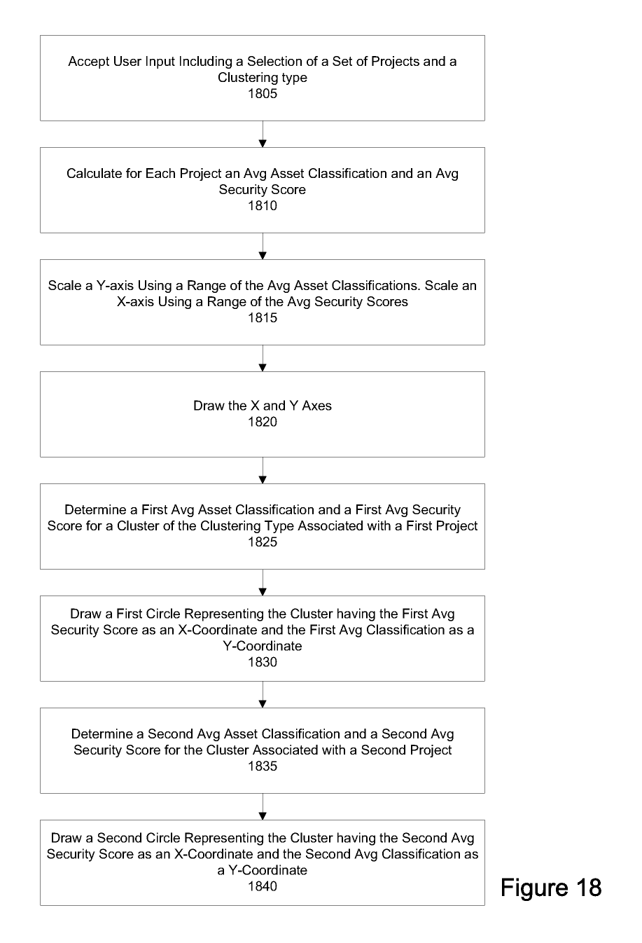

FIG. 18 shows a specific implementation of a flow diagram for making a network security analysis trend tool. In a step 1805, the system accepts user input including a selection of a set of projects and a clustering type. The user input may additionally include one or more filtering options, display options (e.g., display trails, display arrows, and display circles only), or both.

In a step 1810, the system calculates for each project in the set of projects an average asset classification and an average security score.

In a step 1815, the system scales a y-axis of the network security analysis trend tool using a range of the average asset calculations calculated in step 1810. The system scales an x-axis of the network security analysis trend tool using a range of the average security scores calculated in step 1810. This is so that the clusters of the clustering type will be displayed on the network security analysis trend tool.

In a step 1820, the system draws the x and y axes. Typically, the axes are drawn perpendicular to each other.

In a step 1825, the system determines a first average asset classification and a first average security score for a cluster of the selected clustering type associated with a first project.

In a step 1830, the system draws a first circle representing the cluster. The x and y-coordinates of the first circle are the first average security score and the first average classification, respectively.

In a step 1835, the system determines a second average asset classification and a second average security score for the cluster associated with a second project.

In a step 1840, the system draws a second circle representing the cluster. The x and y-coordinates of the second circle are the second average security score and the second average classification, respectively.

Depending on the display options selected by the user, the system may additionally draw a series of overlapping circles (i.e., trails) between the first and second circles, display arrows, or both. A radius of the circles may vary proportionally with the number of assets associated with the circles.

Table G below describes a specific flow for drawing the network security analysis trend tool.

TABLE G

| Step | Description |
|---|---|
| 1 | Accepting a user selection of projects to be graphed, a user selection of clustering |
| | option (e.g., business unit, asset type, domain), and a user selection of filtering option |
| | (e.g., business unit, asset type, domain, task result status). |
| 2 | Defining the coordinate space of the plot by the range of asset classification values |
| | and the range of normalized score values. These are both user configurable. |
| 3 | Querying a database for cluster data: name of each cluster per option selected above, |
| | assign a color to each cluster. |
| 4 | Querying a database for asset data: filters, if specified, are used to select the |
| | appropriate subset of all assets in the database; the query results are averaged per |
| | cluster to arrive at an average asset classification value and assessment result score |
| | value for each cluster for each project. |
| 5 | Mapping each project/cluster point into the coordinate space of the plot. |
| 6 | The user may opt to show fixed-size circles or circles sized in proportion to the |
| | number of assets included. If the latter is selected, each circle's diameter is |
| | proportional to the log of the number of assets averaged to arrive at that point. The |
| | user may also specify a “size scale” which alters the size of all circles equally. |
| 7 | The data points may be shown with or without visual linkage. Two linkage options |
| | are available: “trails” of overlapping circles and “arrows” showing the movement |
| | direction from one project to the next. Only plot points of the same cluster are linked. |
| 8 | When rendering, all the circles in a cluster are drawn in sequence before moving on |
| | to the next cluster. |
| 9 | Plotting the clusters in a defined order so that a specific one appears “on top.” The |
| | user may click on any point in a cluster to bring that cluster forward, meaning that it |
| | is drawn last. |
| 10 | The circles for each cluster define a path from project to project. The distance along |
| | the path from the start is recorded for each circle. |
| 11 | A slider is an integral part of the chart. The units on the slider are the projects being |
| | charted. The slider position defines a point along the path each circle travels from |
| | project to project. |

Table H below describes a specific flow for plotting trails.

TABLE H

| Step | Description |
|---|---|
| 1 | Calculating all the points from project/cluster data. |
| 2 | Calculating the size of each known circle. The size may change |
| | from project to project within a cluster. |
| 3 | Calculating trail circles to smoothly transition from one project to |
| | the next within each cluster. The calculation includes size and |
| | position. The trail circles are positioned to overlap by a fixed |
| | percentage. |
| 4 | Calculating all plot circles (known and interpolated) and storing all |
| | plot circles. |
| 5 | When the slider is moved, redrawing all plot circles up to a |
| | position of the slider, which defines a fraction of the path from the |
| | start. |
| 6 | Drawing trail circles differently from those which correspond to |
| | project/cluster data so that the user can tell which circles can be |
| | double-clicked to obtain more detailed information. |
| 7 | Using double-buffering to avoid flickering. Rendering the plot |
| | off-screen and then displaying the plot all at once. |

Table I below describes a specific flow for plotting with arrows.

TABLE I

| Step | Description |
|---|---|
| 1 | Calculating all the points from project/cluster data. |
| 2 | Calculating the size of each known circle according to user |
| | options selected. |
| 3 | Storing the calculations and results of each circle. |
| 4 | Storing the distance along the path from the first project with |
| | the circles. |
| 5 | When rendering, drawing the circles in a cluster in sequence. |
| | Drawing an arrow, sized in proportion to the user-specified |
| | “size scale.” An arrowhead points from the nth to the (n + 1)th |
| | project. |
| 6 | When the slider is moved, highlighting the circles corresponding |
| | to the project selected by the slider. |
| 7 | Using double-buffering to minimize flickering. |

Table J below describes a specific flow for plotting unlinked circles by deriving a single set of circles from the complete set of project/cluster circles.

TABLE J

| Step | Description |
|---|---|
| 1 | Assigning a weight to each project which corresponds to the slider |
| | position. If the slider is directly on a project, it has weight 1 and all |
| | others have weight 0. If the slider is between two projects, their |
| | weights are assigned based on the ratio of the distance |
| | from the slider to each such that the total weight is 1. |
| 2 | For each cluster, summing the product of the weight and the X |
| | coordinate for each project. |
| 3 | Repeating for the Y coordinate and size. |
| 4 | Assigning these values to the plot circle for the cluster. |
| 5 | On slider movement, performing steps 1-4 and refreshing the plot. |
| | The visual effect is smooth movement between the |
| | project/cluster points. |
| 6 | Using double-buffering to minimize flickering. |

FIG. 19 shows a computer screen displaying an application window showing a specific implementation of a network security analysis trend tool 1905. This network security analysis trend tool is similar to the network security analysis trend tool shown in FIG. 17. However, this network security analysis trend tool includes bubbles 1910 displayed using an isometric view or perspective rendering. That is, the bubbles are displayed at various projections away from the tool. In this specific implementation, a height of a projection is used to indicate a measurement of a specific variable. In a specific implementation, the specific variable is a measurement of risk. However, in various other implementations, the variable measures revenue (e.g., annual revenue), costs (e.g., security costs), volume of network data, business unit asset count, or any other measurement that the user chooses to graph. See FIG. 13 and accompanying discussion.

Thus, a radius of a bubble can indicate a first variable (e.g., an asset count). A distance between the bubble and a plane of the graph can indicate a second variable (e.g., annual revenue), different from the first variable. Other examples of network security analysis trend tools that can be generated by the system are shown in U.S. design patent application 29/322,477, filed Aug. 5, 2008, which is incorporated by reference along with all other references cited in this application.

FIG. 20 shows a computer screen displaying an application window showing a specific implementation of a risk level matrix 2005. This window is displayed when the user selects the risk module and a risk level matrix option. A play button 2008 and slider 2011 are below the matrix. Shapes 2015 overlay the risk level matrix.

The risk level matrix includes an arrangement of rows and columns to quantify risk. In this specific implementation, risk is defined as the product of the likelihood or probability of an occurrence (or threat) and the impact or consequences of that occurrence.

A y-axis or first column of the matrix includes measurement likelihoods such as high, medium, and low. These likelihoods are mapped to numerical values. For example, the high likelihood is mapped to a value of 1.0. The medium likelihood is mapped to a value of 0.5. The low likelihood is mapped to a value of 0.1. These values can be edited by the user via a widget 2020.

An x-axis or first row of the matrix includes a measurement of impacts such as low, medium, and high. These impacts are mapped to numerical values. For example, the low impact is mapped to a value of 10. The medium impact is mapped to a value of 50. The high impact is mapped to a value of 100. These values can be edited by the user via a widget 2025. Although the matrix shows three levels of likelihood and three levels of impact, it should be appreciated that the matrix can show any number of levels of likelihood and any number of levels of impact.

In a specific implementation, risk levels are calculated by multiplying the first row and first column. For example, a first risk level of 10 is calculated by multiplying the high likelihood value (i.e., 1.0) with the low impact value (i.e., 10). A second risk level of 50 is calculated by multiplying the high likelihood value with the medium impact value (i.e., 50). A third risk level of 100 is calculated by multiplying the high likelihood value with the high impact value (i.e., 100), and so forth.

The risk levels are then scaled to qualify a risk level or a range of risk levels as, for example, low, medium, or high. For example, a range of risk levels between 1 and 10 can indicate low risk levels. A range of risk levels between 25 and 50 can indicate medium risk levels. A risk level of 100 or greater can indicate high risk levels. The user can define the numerical ranges of the risk levels using a widget 2030.

In a specific implementation, the risk levels in the matrix are color coded. High risk levels are color coded using a first color. Medium risk levels are color coded using a second color. Low risk levels are color coded a third color. In this specific implementation, the first, second, and third colors are red, yellow, and green, respectively. However, any color can be used.

Similar to FIG. 17, the shapes can be circles or bubbles. In this specific implementation, the shapes indicate clusters of a clustering type selected by the user (e.g., business unit, asset type, and security domain type). The shapes can be color coded to represent specific entities within a selected cluster type.

As shown in the example of FIG. 20, there is a first cluster 2035 of a clustering type, a second cluster 2040 of the clustering type, and a third cluster 2045 of the clustering type. In this specific implementation, the position of the clusters on the risk level matrix indicates an average risk score of the cluster.

The average risk score of a cluster can be determined by first calculating risk scores for each of the assets associated with the cluster. The risk score is calculated by multiplying the likelihood measurement (e.g., probability of a security breach of the asset) by an impact analysis score. In a specific implementation, the impact analysis score is equivalent to the asset classification level. The likelihood measurement may be estimated or determined by the system. The user can override the system's estimation of the likelihood measurement. The average risk score is then calculated by averaging the risk scores for each asset associated with the cluster.

The average risk scores can change over a period of time. For example, as security activities are undertaken, the likelihood of a security breach will decrease which will lower the average risk scores. These changes can be shown graphically by the risk level matrix when the user clicks the play button.

In other words, similar to the network security analysis trend tool shown in FIG. 17, the clusters show trends from one project to another project. For example, the clusters can be associated with first and second projects. When the user clicks the play button, the state of the clusters in the first project are drawn. That is, first, second, and third circles representing the states of the first, second, and third clusters, respectively, at a first time are drawn. Specifically, the first circle is drawn at a position on the matrix indicative of a first average risk score at the first time. The second circle is drawn at a position on the matrix indicative of a second average risk score at the first time. The third circle is drawn at a position on the matrix indicative of a third average risk score at the first time.

As the play or animation continues, the state of the clusters in the second project are drawn. That is, fourth, fifth, and sixth circles representing states of the first, second, and third clusters, respectively, at a second time are drawn. Specifically, the fourth circle is drawn at a position on the matrix indicative of a fourth average risk score at the second time. The fifth circle is drawn at a position on the matrix indicative of a fifth average risk score at the second time. The sixth circle is drawn at a position on the matrix indicative of a sixth average risk score at the second time.

Similar to the network security analysis trend tool shown in FIG. 17, the user can select any number of display options for the circles. For example, a trails display option shows a series of overlapping circles between the circles of the first and second projects. An arrows display option shows arrows between the circles of the first and second projects.

The circles can be clicked on or drilled into to see additional information such as the calculations used to determine the average risk score. In a specific implementation, the circles indicate assets grouped according to a selected cluster type. A diameter of the circle may vary proportionally with a number of assets associated with a specific entity within the selected cluster type.

It should be appreciated that the circle may instead or additionally represent variables such as revenue, security costs, volume of network data, or any other measurement that the user chooses to graph.

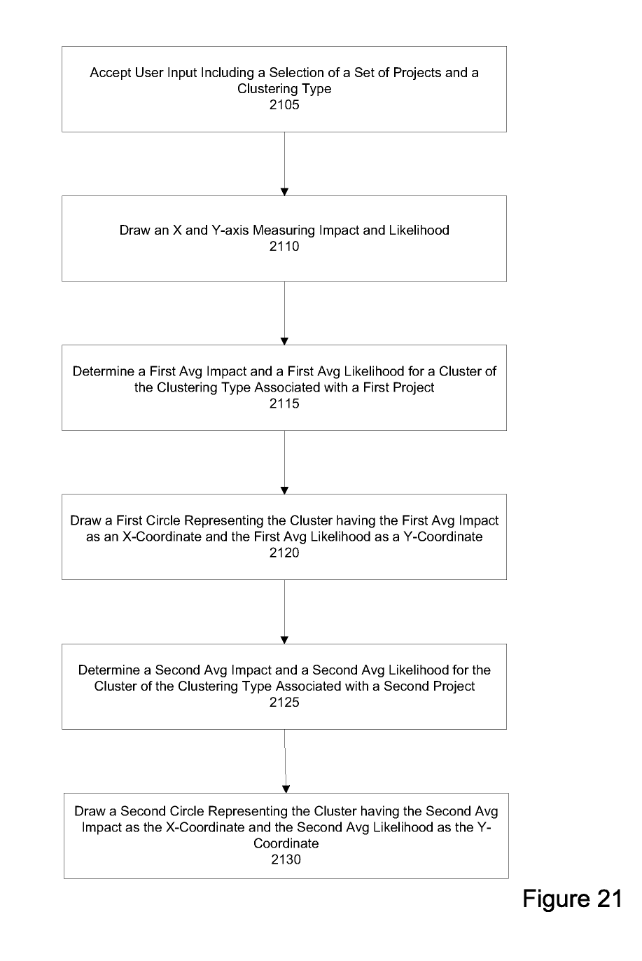

FIG. 21 shows a specific implementation of a flow diagram for making a risk level matrix. In a step 2105, the system accepts user input including a selection of a set of projects and a clustering type. The user input may additionally include one or more filtering options, display options (e.g., display trails, display arrows, and display circles only), or both.

In a step 2110, the system draws an x-axis or row that measures impact. The system draws a y-axis or column that measures likelihood. The x-axis is drawn perpendicular to the y-axis. In a specific implementation, the y-axis is drawn so that it extends below the x-axis.

In a step 2115, the system determines a first average impact and a first average likelihood for a cluster of the clustering type associated with a first project. In a specific implementation, the first average impact is calculated by averaging the asset classification values for each asset associated with the cluster. That is, the system adds the asset classification values and divides the sum by the number of assets associated with the cluster.

In this specific implementation, the first average likelihood is similarly calculated. The first average likelihood is calculated by averaging the likelihood values for each asset associated with the cluster.

In a step 2120, the system draws a first circle representing the cluster. An x-coordinate of the first circle is the first average impact. A y-coordinate of the first circle is the first average likelihood.

In a step 2125, the system determines a second average impact and a second average likelihood for the cluster of the clustering type associated with a second project.

In a step 2130, the system draws a second circle representing the cluster. The x-coordinate of the second circle is the second average impact. The y-coordinate of the second circle is the second average likelihood.

In a specific implementation, the system draws a series of overlapping circles (i.e., trail) between the first and second circles. The system draws an arrow from the first circle to the second circle. A diameter of the first and second circles varies proportionally with a number of assets associated with the cluster. A color of the first and second circles indicate a specific entity within the clustering type.

Some specific implementations of flows are presented in this patent, but it should be understood that the invention is not limited to the specific flows and steps presented. A flow of the invention may have additional steps (not necessarily described in this application), different steps which replace some of the steps presented, fewer steps or a subset of the steps presented, or steps in a different order than presented, or any combination of these. Further, the steps in other implementations of the invention may not be exactly the same as the steps presented and may be modified or altered as appropriate for a particular application or based on the data.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A method comprising:
in a first computer screen, providing a first portion of the screen with a plurality of user-adjustable options;
in the first computer screen, providing a second portion of the screen with a graph having a first axis, a second axis, and at least one reference line;
after a first user-selectable option is selected, animating a plurality of bubbles in the graph; and
while the plurality of bubbles are being animated, not moving the at least one reference line from a fixed position, wherein the plurality of bubbles move in motion relative to the fixed position of the at least one reference line.

2. The method of claim 1 wherein the reference line is a curved line.

3. The method of claim 1 wherein a first reference line of the at least one reference line is a straight line and a second reference line of the at least one reference line is a curved line.

4. The method of claim 1 wherein the reference line touches a point where the first axis and second axis touch.

5. The method of claim 1 comprising:
upon a user selecting one of the bubbles in motion at a first time step, displaying in a second screen information associated with the selected bubble at a time represented by the graph in the first time step.

6. The method of claim 5 comprising:
upon a user selecting one of the bubbles in motion at a second time step, subsequent to the first time step, displaying in a third screen information associated with the selected bubble at a time represented by the graph in the second time step, wherein the information in the third screen is different from the information in the second screen.

7. The method of claim 1 wherein one of the plurality of user-adjust options comprises a display trails option.

8. The method of claim 1 comprising:
for a first region of the graph that is a first distance range away from reference line, showing the first region using a first color; and
for a second region of the graph that is a second distance range away from reference line, showing the second region using a second color, different from the first.

9. The method of claim 8 comprising:
showing in the graph at least a first and third region in the first color; and
showing in the graph at least a second and fourth region in the first color.

10. The method of claim 9 wherein the first and second regions are on a first side of the reference line while the third and fourth regions are on a second side of the reference line.

11. The method of claim 8 wherein the in the first computer screen, providing a second portion of the screen with a graph having a first axis, a second axis, and at least one reference line comprises:
drawing the first reference line on the first screen using a broken line; and
drawing the first axis using a solid line.

12. A method comprising:
in a first computer screen, drawing a first fixed reference line of a graph;
drawing a second fixed reference line of the graph;
drawing a third fixed reference line of the graph, wherein the third fixed reference line is not parallel to either the first fixed or second fixed reference line;
animating a first circle and a second circle of the graph, whereby the first and second circle are in motion relative to the third fixed reference line;
showing a first region of the graph that is a first distance range away from third reference line using a first color; and
showing a second region of the graph that is a second distance range away from third reference line using a second color, different from the first.

13. The method of claim 12 comprising:
when hovering a pointing device over the first circle, displaying a numerical value that is representative of a distance of the first circle from the third reference line.

14. The method of claim 13 wherein as the first circle moves relative to the third reference line, the numerical value changes on the screen in real time.

15. A method comprising:
in a first computer screen, drawing a first fixed reference line of a graph;
drawing a second fixed reference line of the graph;
drawing a third fixed reference line of the graph, wherein the third fixed reference line is not parallel to either the first fixed or second fixed reference line;
drawing a fourth fixed reference line of the graph, wherein the fourth fixed reference line is not parallel to either the first fixed, second fixed, or third fixed reference line;
animating a first circle and a second circle of the graph, whereby the first and second circle are in motion relative to the third and fourth fixed reference lines;
showing a first region of the graph that is between the third and fourth fixed reference lines using a first color; and
showing a second region of the graph that is outside the third and fourth fixed reference lines using a second color, different from the first color.

16. The method of claim 15 wherein the third fixed reference line is a straight line while the fourth fixed reference line a curved line.
